(19) United States
(12) Patent Application Publication
(10) Pub. No.: US 2023/0357883 A1
(43) Pub. Date: Nov. 9, 2023

(54) DEHYDROGENATION APPARATUS, STEEL SHEET PRODUCTION SYSTEM, AND STEEL SHEET PRODUCTION METHOD

(71) Applicant: JFE STEEL CORPORATION, Chiyoda-ku, Tokyo (JP)

(72) Inventors: Yuki TOJI, Chiyoda-ku, Tokyo (JP); Kazuki ENDOH, Chiyoda-ku, Tokyo (JP); Hidekazu MINAMI, Chiyoda-ku, Tokyo (JP)

(73) Assignee: JFE STEEL CORPORATION, Chiyoda-ku, Tokyo (JP)

(21) Appl. No.: 18/004,880

(22) PCT Filed: May 7, 2021
(86) PCT No.: PCT/JP2021/017602

§ 371 Date: Jan. 10, 2023

(30) Foreign Application Priority Data
Jul. 14, 2020 (JP) 2020-120970
Jul. 14, 2020 (JP) 2020-120973

(51) Int. Cl. C21D 10/00; C21D 9/46; C21D 8/02; C21D 6/00; C22C 38/60; C22C 38/40; C22C 38/38; C22C 38/28; C22C 38/26; C22C 38/22; C22C 38/20; C22C 38/16; C22C 38/14; C22C 38/12; C22C 38/08; C22C 38/06; C22C 38/04; C22C 38/02; C22C 38/00

(52) U.S. Cl. CPC C21D 10/00; C21D 9/46; C21D 8/0205; C21D 8/0226; C21D 8/0236; C21D 8/0263; C21D 8/0278; C21D 6/001; C21D 6/002; C21D 6/004; C21D 6/005; C21D 6/008; C22C 38/60; C22C 38/40; C22C 38/38; C22C 38/28; C22C 38/26; C22C 38/22; C22C 38/20; C22C 38/16; C22C 38/14; C22C 38/12; C22C 38/08; C22C 38/06; C22C 38/04; C22C 38/02; C22C 38/008; C22C 38/005; C22C 38/002; C22C 38/001; C23C 2/40

(57) ABSTRACT

Provided are a steel sheet dehydrogenation apparatus, a steel sheet production system, and a steel sheet production method capable of producing a steel sheet excellent in hydrogen embrittlement resistance without changing the mechanical properties of the steel sheet. A dehydrogenation apparatus comprises: a housing configured to house a steel sheet coil obtained by coiling a steel strip; and a sound wave irradiator configured to irradiate the steel sheet coil housed in the housing with sound waves to obtain a product coil.

### TECHNICAL FIELD

The present disclosure relates to a dehydrogenation apparatus and a steel sheet production system for producing a steel sheet suitable as a member used in the industrial fields of automobiles, home electric appliances, building materials, etc. The present disclosure especially relates to a dehydrogenation apparatus, a steel sheet production system, and a steel sheet production method for obtaining a steel sheet having low diffusible hydrogen content in steel and excellent hydrogen embrittlement resistance.

### BACKGROUND

As a concern specific to high strength steel sheets, it is known that hydrogen entering into a steel sheet embrittles the steel sheet (hydrogen embrittlement). In the case of annealing a steel sheet using a continuous annealing line or a continuous hot-dip galvanizing line, a H₂—N₂ mixed gas, which is often used as a reducing or non-oxidizing gas, is introduced into an annealing furnace. Due to annealing in the H₂—N₂ mixed gas, hydrogen enters into the steel. Moreover, in steel sheets for automobiles, hydrogen generated due to the corrosion reaction that progresses in the use environment of automobiles enters into the steel. Unless the diffusible hydrogen that has entered into the steel is sufficiently reduced, the diffusible hydrogen is likely to embrittle the steel sheet and cause a delayed fracture.

Various studies have conventionally been conducted on methods of reducing the diffusible hydrogen content in steel. For example, JP 6562180 B1 (PTL 1) discloses a method of reducing the amount of hydrogen trapped in steel by performing an aging treatment after an annealing treatment and elongation rolling. Another known method of reducing diffusible hydrogen involves leaving a steel sheet after annealing at room temperature for a long time to desorb diffusible hydrogen from the surface of the steel sheet. WO 2019/188642 A1 (PTL 2) discloses a method of reducing the diffusible hydrogen content in steel by holding a cold-rolled and annealed steel sheet in a temperature range of 50° C. or more and 300° C. or less for 1800 seconds or more and 3200 seconds or less.

### CITATION LIST

### Patent Literature

PTL 1: JP 6562180 B1
PTL 2: Specification of WO 2019/188642 A1

### SUMMARY

### Technical Problem

With the methods described in PTL 1 and PTL 2, there is a possibility that microstructural changes occur due to heating and holding after annealing. It is therefore difficult to apply the methods described in PTL 1 and PTL 2 to other steel sheets. Besides, the method of leaving a steel sheet at room temperature is low in productivity because the steel sheet needs to be left for a long time.

It could therefore be helpful to provide a steel sheet dehydrogenation apparatus, a steel sheet production system, and a steel sheet production method capable of producing a steel sheet excellent in hydrogen embrittlement resistance without changing the mechanical properties of the steel sheet.

### Solution to Problem

Upon careful examination, we discovered that, by irradiating a steel sheet with sound waves under predetermined conditions, the diffusible hydrogen content in the steel can be reduced to suppress hydrogen embrittlement. The mechanism behind this is presumed to be as follows: By irradiating the steel sheet with sound waves to forcibly microvibrate the steel sheet, the steel sheet undergoes repeated bending deformation. As a result, the lattice spacing of the surface expands as compared with the mid-thickness part of the steel sheet. Hydrogen in the steel sheet diffuses toward the surface of the steel sheet with wide lattice spacing and low potential energy, and desorbs from the surface.

The present disclosure is based on these discoveries. We thus provide the following.

[1] A dehydrogenation apparatus comprising: a housing configured to house a steel sheet coil obtained by coiling a steel strip; and a sound wave irradiator configured to irradiate the steel sheet coil housed in the housing with sound waves to obtain a product coil.

[2] The dehydrogenation apparatus according to [1], wherein an intensity of the sound waves generated from the sound wave irradiator and a position of the sound wave irradiator are set so that a maximum sound pressure level at a surface of the steel sheet coil will be 30 dB or more.

[3] The dehydrogenation apparatus according to [1] or [2], further comprising a heater configured to heat the steel sheet coil while the steel sheet coil is irradiated with the sound waves.

[4] A dehydrogenation apparatus comprising: an uncoiler configured to uncoil a steel sheet coil to feed a steel strip; a sheet passing device configured to pass the steel strip therethrough; a coiler configured to coil the steel strip; and a sound wave irradiator configured to irradiate the steel strip being passed through the sheet passing device with sound waves to obtain a product coil.

[5] The dehydrogenation apparatus according to [4], wherein an intensity of the sound waves generated from the sound wave irradiator and a position of the sound wave irradiator are set so that a maximum sound pressure level at a surface of the steel strip will be 30 dB or more.

[6] The dehydrogenation apparatus according to [4] or [5], further comprising a heater configured to heat the steel strip while the steel strip is irradiated with the sound waves.

[7] The dehydrogenation apparatus according to any one of [1] to [5], further comprising a sound absorber configured to prevent the sound waves from leaking out of the dehydrogenation apparatus.

[8] A steel sheet production system comprising: a hot rolling mill configured to subject a steel slab to hot rolling to obtain a hot-rolled steel sheet; a hot-rolled steel sheet coiler configured to coil the hot-rolled steel sheet to obtain a hot-rolled coil; and the dehydrogenation apparatus according to any one of [1] to [7] configured to use the hot-rolled coil as the steel sheet coil.

[9] A steel sheet production system comprising: a cold rolling mill configured to subject a hot-rolled steel sheet to cold rolling to obtain a cold-rolled steel sheet; a cold-rolled steel sheet coiler configured to coil the cold-rolled steel sheet to obtain a cold-rolled coil; and the dehydrogenation apparatus according to any one of [1] to [7] configured to use the cold-rolled coil as the steel sheet coil.

[10] A steel sheet production system comprising: a batch annealing furnace configured to subject a cold-rolled coil or a hot-rolled coil to batch annealing to obtain an annealed coil; and the dehydrogenation apparatus according to any one of [1] to [7] configured to use the annealed coil as the steel sheet coil.

[11] A steel sheet production system comprising: a pre-annealing uncoiler configured to uncoil a cold-rolled coil or a hot-rolled coil to feed a cold-rolled steel sheet or a hot-rolled steel sheet, respectively; a continuous annealing furnace configured to subject the cold-rolled steel sheet or the hot-rolled steel sheet to continuous annealing to obtain an annealed steel sheet; an annealed steel sheet coiler configured to coil the annealed steel sheet to obtain an annealed coil; and the dehydrogenation apparatus according to any one of [1] to [7] configured to use the annealed coil as the steel sheet coil.

[12] A steel sheet production system comprising: a coating or plating apparatus configured to form a coating or plating on a surface of a hot-rolled steel sheet or a cold-rolled steel sheet to obtain a coated or plated steel sheet; a coated or plated steel sheet coiler configured to coil the coated or plated steel sheet to obtain a coated or plated steel sheet coil; and the dehydrogenation apparatus according to any one of [1] to [7] configured to use the coated or plated steel sheet coil as the steel sheet coil.

[13] The steel sheet production system according to [12], wherein the coating or plating apparatus is a hot-dip galvanizing apparatus.

[14] The steel sheet production system according to [12], wherein the coating or plating apparatus includes: a hot-dip galvanizing apparatus; and an alloying furnace following the hot-dip galvanizing apparatus.

[15] The steel sheet production system according to [12], wherein the coating or plating apparatus is an electroplating apparatus.

[16] A steel sheet production method comprising a sound wave irradiation step of irradiating a steel sheet coil obtained by coiling a steel strip with sound waves so that a sound pressure at a surface of the steel sheet coil will be 30 dB or more, to obtain a product coil.

[17] The steel sheet production method according to [16], wherein the sound wave irradiation step is performed while holding the steel sheet coil at 300° C. or less.

[18] A steel sheet production method comprising: a step of uncoiling a steel sheet coil to feed a steel strip; a sheet passing step of passing the steel strip; and a step of coiling the steel strip to obtain a product coil, wherein the sheet passing step includes a sound wave irradiation step of irradiating the steel strip with sound waves so that a sound pressure level at a surface of the steel strip will be 30 dB or more.

[19] The steel sheet production method according to [18], wherein the sound wave irradiation step is performed while holding the steel strip at 300° C. or less.

[20] The steel sheet production method according to any one of [16] to [19], comprising: a step of subjecting a steel slab to hot rolling to obtain a hot-rolled steel sheet; and a step of coiling the hot-rolled steel sheet to obtain a hot-rolled coil, wherein the hot-rolled coil is the steel sheet coil.

[21] The steel sheet production method according to any one of [16] to [19], comprising: a step of subjecting a hot-rolled steel sheet to cold rolling to obtain a cold-rolled steel sheet; and a step of coiling the cold-rolled steel sheet to obtain a cold-rolled coil, wherein the cold-rolled coil is the steel sheet coil.

[22] The steel sheet production method according to any one of [16] to [19], comprising a step of subjecting a cold-rolled coil or a hot-rolled coil to batch annealing to obtain an annealed coil, wherein the annealed coil is the steel sheet coil.

[23] The steel sheet production method according to any one of [16] to [19], comprising: a step of uncoiling a cold-rolled coil or a hot-rolled coil to feed a cold-rolled steel sheet or a hot-rolled steel sheet, respectively; a step of subjecting the cold-rolled steel sheet or the hot-rolled steel sheet to continuous annealing to obtain an annealed steel sheet; and a step of coiling the annealed steel sheet to obtain an annealed coil, wherein the annealed coil is the steel sheet coil.

[24] The steel sheet production method according to any one of [16] to [19], comprising: a coating or plating step of forming a coating or plating on a surface of a hot-rolled steel sheet or a cold-rolled steel sheet to obtain a coated or plated steel sheet; and a step of coiling the coated or plated steel sheet to obtain a coated or plated steel sheet coil, wherein the coated or plated steel sheet coil is the steel sheet coil.

[25] The steel sheet production method according to [24], wherein the coating or plating step includes a hot-dip galvanizing step.

[26] The steel sheet production method according to [24], wherein the coating or plating step includes: a hot-dip galvanizing step; and an alloying step following the hot-dip galvanizing step.

[27] The steel sheet production method according to [24], wherein the coating or plating step includes an electroplating step.

[28] The steel sheet production method according to any one of [16] to [27], wherein the product coil is composed of a high strength steel sheet having a tensile strength of 590 MPa or more.

[29] The steel sheet production method according to any one of [16] to [28], wherein the product coil includes a base steel sheet having a chemical composition containing (consisting of), in mass %, C: 0.030% or more and 0.800% or less, Si: 0.01% or more and 3.00% or less, Mn: 0.01% or more and 10.00% or less, P: 0.001% or more and 0.100% or less, S: 0.0001% or more and 0.0200% or less, N: 0.0005% or more and 0.0100% or less, and Al: 2.000% or less, with the balance being Fe and inevitable impurities.

[30] The steel sheet production method according to [29], wherein the chemical composition further contains, in mass %, at least one element selected from the group consisting of Ti: 0.200% or less, Nb: 0.200% or less, V: 0.500% or less, W: 0.500% or less, B: 0.0050% or less, Ni: 1.000% or less, Cr: 1.000% or less, Mo: 1.000% or less, Cu: 1.000% or less, Sn: 0.200% or less, Sb: 0.200% or less, Ta: 0.100% or less, Ca: 0.0050% or less, Mg: 0.0050% or less, Zr: 0.0050% or less, and REM: 0.0050% or less.

[31] The steel sheet production method according to any one of [16] to [28], wherein the product coil includes a stainless steel sheet having a chemical composition containing (consisting of), in mass %, C: 0.001% or more and 0.400% or less, Si: 0.01% or more and 2.00% or less, Mn: 0.01% or more and 5.00% or less, P: 0.001% or more and 0.100% or less, S: 0.0001% or more and 0.0200% or less, Cr: 9.0% or more and 28.0% or less, Ni: 0.01% or more and 40.0% or less, N: 0.0005% or more and 0.500% or less, and Al: 3.000% or less, with the balance being Fe and inevitable impurities.

[32] The steel sheet production method according to [31], wherein the chemical composition further contains, in mass %, at least one element selected from the group consisting of Ti: 0.500% or less, Nb: 0.500% or less, V: 0.500% or less, W: 2.000% or less, B: 0.0050% or less, Mo: 2.000% or less, Cu: 3.000% or less, Sn: 0.500% or less, Sb: 0.200% or less, Ta: 0.100% or less, Ca: 0.0050% or less, Mg: 0.0050% or less, Zr: 0.0050% or less, and REM: 0.0050% or less.

[33] The steel sheet production method according to any one of [16] to [32], wherein the product coil has a diffusible hydrogen content of 0.50 mass ppm or less.

### Advantageous Effect

It is thus possible to produce a steel sheet excellent in hydrogen embrittlement resistance without changing the mechanical properties of the steel sheet.

### BRIEF DESCRIPTION OF THE DRAWINGS

In the accompanying drawings:

FIG. 1 is a view illustrating an example of the structure of a sound wave irradiator;

FIG. 2A is a perspective view schematically illustrating an example of the structure of a dehydrogenation apparatus according to Embodiment 1;

FIG. 2B is a view of the dehydrogenation apparatus as seen from a side surface a;

FIG. 2C is a view of an example of the dehydrogenation apparatus as seen from a side surface b;

FIG. 2D is a view of another example of the dehydrogenation apparatus as seen from the side surface b;

FIG. 3 is a view illustrating an example of the structure of a dehydrogenation apparatus according to Embodiment 2 as seen from the coiling axial direction of a steel sheet coil;

FIG. 4A is a view illustrating an example of the arrangement of sound wave irradiators with respect to a steel sheet fed, in the dehydrogenation apparatus according to Embodiment 2; and

FIG. 4B is a view illustrating another example of the arrangement of sound wave irradiators with respect to a steel sheet fed, in the dehydrogenation apparatus according to Embodiment 2.

### DETAILED DESCRIPTION

Embodiments of the present disclosure will be described below, although the present disclosure is not limited to such embodiments. Herein, each numeric value range expressed in the form of “A to B” denotes a range that includes values A and B as its lower and upper limits. Herein, the term “steel sheet” is a general term that includes a hot-rolled steel sheet, a cold-rolled steel sheet, an annealed steel sheet obtained by annealing the hot-rolled steel sheet or the cold-rolled steel sheet, and a coated or plated steel sheet obtained by forming a coating or plating on the surface of the hot-rolled steel sheet, cold-rolled steel sheet, or annealed steel sheet. The shape of the “steel sheet” is not limited, and includes both a steel sheet coil and a steel strip fed as a result of uncoiling a steel sheet coil.

A dehydrogenation apparatus according to the present disclosure irradiates a steel sheet with sound waves to reduce the diffusible hydrogen content in the steel. This dehydrogenation apparatus does not need a heating treatment for the steel sheet, and thus can reduce the diffusible hydrogen content in the steel without changing the microstructural properties of the steel sheet.

A steel sheet production method according to the present disclosure irradiates a steel sheet with sound waves so that the sound pressure level at the surface of the steel sheet will be 30 dB or more. This steel sheet production method does not need a heating treatment for the steel sheet, and thus can reduce the diffusible hydrogen content in the steel without changing the microstructural properties of the steel sheet.

Although the reason why irradiating a steel sheet with sound waves improves the hydrogen embrittlement resistance of the steel sheet is not clear, we presume the reason as follows:

As a result of irradiating the steel sheet with sound waves under predetermined conditions, the steel sheet is forcibly vibrated. Due to the bending deformation caused by the forced vibration, the lattice spacing of the steel sheet repeats expansion (tension) and contraction (compression) in the thickness direction. Since diffusible hydrogen in steel is induced to diffuse to the tensile side with lower potential energy, the diffusion of diffusible hydrogen is promoted with the expansion and contraction of the lattice spacing, and the diffusion path of diffusible hydrogen connecting the inside and the surface of the steel sheet is forcibly created. Diffusible hydrogen whose diffusion path has been forcibly formed escapes through the surface to the outside of the steel sheet, which is more advantageous in terms of potential energy, at the timing when the lattice spacing near the surface of the steel sheet expands. In this way, the sound waves applied to the steel sheet under the predetermined conditions reduce the diffusible hydrogen in the steel sufficiently and efficiently, so that hydrogen embrittlement of the steel sheet can be suppressed favorably and easily.

The following will separately describe (1) a dehydrogenation apparatus and a steel sheet production method that irradiate a steel sheet coil with sound waves, and (2) a dehydrogenation apparatus and a steel sheet production method that uncoil a steel sheet coil to feed a steel sheet, irradiate the steel sheet with sound waves, and recoil the steel sheet.

### Embodiment 1

A dehydrogenation apparatus according to this embodiment comprises: a housing configured to house a steel sheet coil C obtained by coiling a steel strip; and a sound wave irradiator configured to irradiate the steel sheet coil housed in the housing with sound waves to obtain a product coil. In various steps in steel sheet production, a steel strip is coiled to form a steel sheet coil.

A steel sheet production method according to this embodiment comprises a sound wave irradiation step of irradiating a steel sheet coil obtained by coiling a steel strip with sound waves so that a sound pressure level at a surface of the steel sheet coil will be 30 dB or more, to obtain a product coil. In various steps in steel sheet production, a steel strip is coiled to form a steel sheet coil.

With the dehydrogenation apparatus and the steel sheet production method according to this embodiment, by irradiating the steel sheet coil with sound waves, the diffusible hydrogen content in the steel can be reduced and a steel sheet excellent in hydrogen embrittlement resistance can be obtained. In particular, in the steel sheet coil, the steel strip is subjected to bending deformation and the lattice spacing on the radially outer surface of the steel strip is expanded, and therefore the diffusion path of hydrogen is likely to be formed radially outward. In this embodiment, by irradiating the steel sheet coil with sound waves, the steel strip in a state in which the lattice spacing on the radially outer surface is expanded is further subjected to minute bending deformation, with it being possible to reduce diffusible hydrogen in the steel more favorably.

[[Sound Wave Irradiator]]

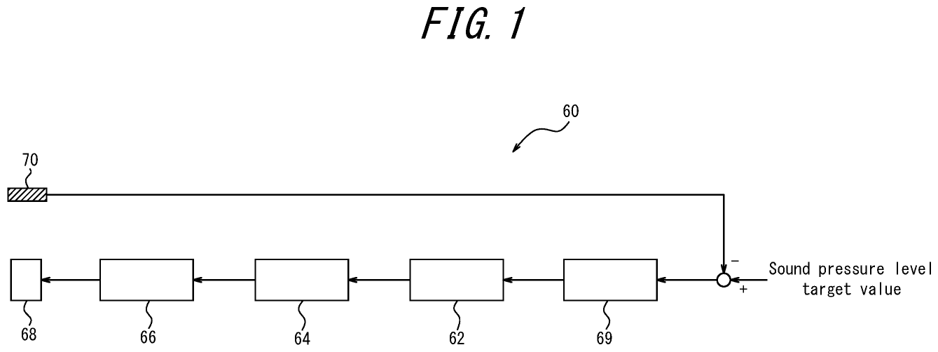

A typical sound wave irradiator (i.e. a sound wave generator) can be used for sound wave irradiation. FIG. 1 illustrates an example of the structure of a sound wave irradiator. As illustrated in FIG. 1, for example, a sound wave irradiator 60 includes a sound pressure controller 69, a sound wave oscillator 62, a vibration transducer 64, a booster 66, and a horn 68. The sound wave oscillator 62 converts an electrical signal of a typical frequency (for example, 50 Hz or 60 Hz) into an electrical signal of a desired frequency, and transmits the electrical signal to the vibration transducer 64. While the voltage is typically AC 200 V to 240 V, it is amplified to nearly 1000 V in the sound wave oscillator 62. The electric signal of the desired frequency transmitted from the sound wave oscillator 62 is converted into mechanical vibration energy by a piezoelectric element in the vibration transducer 64, and the mechanical vibration energy is transmitted to the booster. The booster 66 amplifies the amplitude of the vibration energy transmitted from the vibration transducer 64 (or converts it into an optimum amplitude), and transmits the resultant vibration energy to the horn 68. The horn 68 is a member that imparts directivity to the vibration energy transmitted from the booster 66 and propagates it through the air as directional sound waves. In one example, the horn 68 may be a cylindrical member from the viewpoint of irradiating the steel sheet coil with sound waves of high directivity. Further, a sound level meter 70 detects the sound pressure level at the steel sheet coil surface, and outputs the sound pressure level to the sound pressure controller 69. The sound pressure controller 69 compares a target value of the sound pressure at the steel sheet coil surface and the actual value of the sound pressure detected by the sound level meter 70, adjusts the sound pressure level via the booster 66 so that the actual value will match the target value, and emits sound waves from the horn 68.

[[Dehydrogenation Apparatus]]

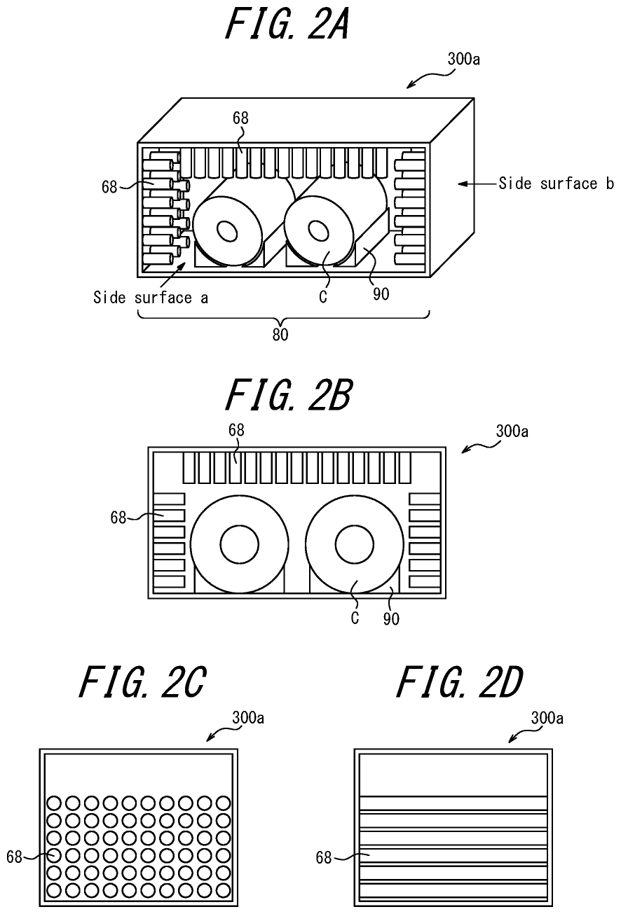

In this steel sheet production method, how the steel sheet coil is irradiated with sound waves is not limited. As an example, the horn 68 may be a cylindrical member from the viewpoint of irradiating the steel sheet coil with sound waves of high directivity. FIGS. 2A to 2D illustrate an example of a dehydrogenation apparatus for irradiating a steel sheet coil with sound waves to reduce diffusible hydrogen in the steel. FIG. 2A is a perspective view of a dehydrogenation apparatus 300a. Only the rows of horns 68 on the frontmost side as seen from a side surface a of the dehydrogenation apparatus 300a are illustrated in FIG. 2A. FIG. 2B is a view of the dehydrogenation apparatus 300a as seen from the side surface a. As illustrated in FIGS. 2A and 2B, the dehydrogenation apparatus 300a comprises a housing 80 configured to house a steel sheet coil C, and horns 68 configured to irradiate the steel sheet coil C housed in the housing 80 with sound waves. The number of horns 68 and the arrangement of the horns 68 are not limited. In the example in FIGS. 2A to 2D, a plurality of horns 68 are arranged so as to surround the steel sheet coil C. Although not illustrated in FIGS. 2A to 2D, each horn 68 is coupled with a booster 66, a vibration transducer 64, a sound wave oscillator 62, and a sound pressure controller 69 in this order, and the steel sheet coil C is irradiated with sound waves from the horn 68. As a result of arranging the plurality of horns 68 so as to surround the steel sheet coil C, the steel sheet coil C can be uniformly irradiated with sound waves. In the case where the horns 68 are provided so as to surround the steel sheet coil C as illustrated in FIG. 2A, sound wave irradiation is expected to be carried out in the following manner: The sound waves emitted from the horns 68 vibrate the coil surface of the steel sheet coil C. In the steel sheet coil C whose coil surface is vibrated, the vibration propagates toward the inner circumference of the coil through the air existing between the steel sheets in the steel sheet coil C or the vibration propagates from the outermost surface of the coil directly toward the inner circumference of the coil, and eventually the vibration propagates to the innermost part of the coil. As illustrated in the drawing, the housing 80 may be capable of housing a plurality of steel sheet coils C.

From the viewpoint of uniformly irradiating the entire surface of the steel sheet coil C with sound waves, it is preferable to arrange a plurality of horns in the height direction and the width direction of the inner walls of the dehydrogenation apparatus 300a so as to surround the steel sheet coil C. FIG. 2C is a view of an example of the dehydrogenation apparatus seen from a side surface b. As illustrated in FIG. 2C, cylindrical horns 68 may be arranged at uniform intervals in the height direction and the width direction of the side surface b. FIG. 2D is a view of another example of the dehydrogenation apparatus seen from the side surface b. The horns 68 may be in any shape as long as they are capable of irradiating the steel sheet coil C with sound waves. For example, the horns 68 may be rectangular tubes with a rectangular cross-sectional shape, as illustrated in FIG. 2D. Moreover, horns 68 may be inserted into the hollow portion defined by the steel sheet coil C to irradiate the steel sheet coil C with sound waves from inside.

Since diffusible hydrogen is also released from the end surfaces of the steel sheet coil C, the efficiency of reducing the diffusible hydrogen content is lower in the steel sheet transverse center part than in the steel sheet transverse edge part of the steel sheet coil C. Hence, it is particularly preferable to provide horns 68 around the steel sheet transverse center part of the steel sheet coil C.

A coil holder 90 is provided in the dehydrogenation apparatus 300a as appropriate, as illustrated in the drawing. The form of the coil holder 90 is not limited. In the case where the steel sheet coil C is placed so that the coiling axial direction of the steel sheet coil C will be parallel to the floor of the dehydrogenation apparatus 300a, the coil holder 90 may be a pair of rod-shaped members that sandwich the steel sheet coil C from both sides in order to prevent the steel sheet coil C from rolling within the dehydrogenation apparatus 300a, as illustrated in FIG. 2A. The coil holder 90 may be a pair of rod-shaped members having a concave arcuate upper surface along the arc drawn by the outermost periphery of the steel sheet coil C, as illustrated in FIG. 2A. Although not illustrated, the steel sheet coil C may be placed so that the coiling axial direction will be parallel to the floor of the dehydrogenation apparatus 300a.

[[Frequency]]

The frequency of the sound waves emitted by the sound wave irradiator 60 is not limited, and can be set depending on the type of the steel sheet coil C housed in the housing 80. The frequency of the sound waves emitted by the sound wave irradiator 60 is preferably 10 Hz or more, from the viewpoint of further promoting the diffusion of hydrogen without the vibration being hindered due to the rigidity of the steel sheet. The “frequency” herein indicates the frequency (Hz) on the sound wave output side set in any sound wave irradiator. When the frequency is higher, the directivity of the sound waves is higher, so that the sound wave irradiation position can be controlled more easily. Therefore, the frequency of the sound waves is more preferably 100 Hz or more, further preferably 500 Hz or more, and most preferably 1000 Hz or more, 3000 Hz or more, or 5000 Hz or more. No upper limit is placed on the frequency of the sound waves, but the frequency of the sound waves is preferably 100 kHz or less, more preferably 80 kHz or less, and further preferably 50 kHz or less. If the frequency of the sound waves is 100,000 Hz or less, the attenuation of the sound wave vibration in the air can be favorably prevented, and the steel sheet can be excited sufficiently. The frequency of the sound waves emitted by the sound wave irradiator 60 can be controlled by adjusting the frequency and waveform of the AC voltage signal fed from the sound wave oscillator to the vibration transducer.

[[Sound Pressure Level]]

One of the important constituent features of the steel sheet production method according to this embodiment is to irradiate the steel sheet coil with sound waves having a sound pressure level of 30 dB or more at the surface of the steel sheet coil. It is therefore preferable to set, in the dehydrogenation apparatus 300a according to this embodiment, the strength of the sound waves generated from the sound wave irradiator 60 and the position of the sound wave irradiator 60 so that the maximum sound pressure level at the surface of the steel sheet coil C will be 30 dB or more. The surface of the steel sheet coil C herein refers to the surface of the steel sheet located on the outermost periphery of the steel sheet coil C. If the sound pressure level of the sound waves applied is less than 30 dB, the vibration to be imparted to the steel sheet by the applied sound waves is hindered by the rigidity of the steel sheet itself, and the diffusion of hydrogen to outside the steel sheet is not promoted. This results in insufficient reduction of the diffusible hydrogen content in the steel. The maximum sound pressure level of the applied sound waves at the surface of the steel sheet coil C is more preferably 60 dB or more, and further preferably 80 dB or more. When the sound pressure level of the applied sound waves is higher, the vibration of the steel sheet is greater, so that more residual hydrogen can be released from the steel to improve the hydrogen embrittlement resistance. Given the performance of the sound wave irradiator 60 which is commonly available, the strength of the sound waves generated from the sound wave irradiator 60 and the position of the sound wave irradiator 60 may be typically set so that the maximum sound pressure level at the surface of the steel sheet coil C will be 150 dB or less. The sound pressure level herein can be measured by installing a sound pressure meter near the surface of the steel sheet coil and directly below the sound wave irradiator 60. Alternatively, once the intensity I of the sound waves generated from the sound wave irradiator 60 and the distance D between the sound wave irradiator and the steel sheet coil have been determined, the sound pressure level at the surface of the steel sheet coil can be measured offline. In detail, the sound pressure level at the surface of the steel sheet coil can be measured by installing a sound pressure meter at a position of the distance D from an offline sound wave irradiator that generates sound waves of the intensity I in the main traveling direction of the sound waves.

[[Irradiation Time]]

The sound wave irradiation time for the steel sheet coil C is not limited. In this embodiment, the steel sheet coil is irradiated with sound waves after hot rolling or after cold rolling, and accordingly there is no constraint on the sound wave irradiation time unlike in the case where the steel strip being passed is irradiated with sound waves. Since a longer sound wave irradiation time is expected to contribute to reduction of more diffusible hydrogen, the sound wave irradiation time is preferably 1 minute or more. The sound wave irradiation time is more preferably 30 minutes or more, and further preferably 60 minutes or more. From the viewpoint of productivity, the sound wave irradiation time is preferably 30000 minutes or less, more preferably 10000 minutes or less, and further preferably 1000 minutes or less. The sound wave irradiation time can be controlled, for example, by controlling the drive time of the sound wave irradiator 60 by the controller.

[[Heater]]

[[Holding Temperature of Steel Sheet Coil]]

The dehydrogenation apparatus 300a may further comprise a heater configured to heat the steel sheet coil C while the steel sheet coil C is irradiated with sound waves. The temperature of the steel sheet coil C in the sound wave irradiation step is not limited. According to this embodiment, diffusible hydrogen in the steel can be reduced even without heating and holding the steel sheet coil C. By irradiating the steel sheet coil C with sound waves while heating the steel sheet coil C by the heater, however, the hydrogen diffusion rate can be further increased, as a result of which the diffusible hydrogen content in the steel can be further reduced. Accordingly, the temperature of the steel sheet coil C when applying sound waves is preferably 30° C. or more, more preferably 50° C. or more, and further preferably 100° C. or more. No upper limit is placed on the temperature of the steel sheet coil C in the sound wave irradiation step, but the temperature of the steel sheet coil C in the sound wave irradiation step is preferably 300° C. or less except in the case of performing sound wave irradiation during batch annealing as described later, from the viewpoint of appropriately preventing the microstructural changes of the steel sheet coil C. In this embodiment, the temperature of the steel sheet coil C when applying sound waves is based on the temperature at a ½ position in the radial direction of the steel sheet coil. The temperature at the ½ position in the radial direction of the steel sheet coil can be measured by directly inserting a thermocouple at the ½ position in the radial direction of the steel sheet coil and measuring the temperature of the steel strip present at the ½ position in the radial direction. The method of heating the steel sheet coil C may be a typical method, such as a method of installing a heater on the side wall of the housing or a method of blowing high-temperature air generated outside to the housing and circulating it in the housing.

The dehydrogenation apparatus 300a according to this embodiment may further comprise a sound absorber configured to prevent the sound waves from leaking out of the dehydrogenation apparatus 300a. The sound absorber may be, for example, a sound absorbing material provided so as to surround the inner wall of the housing 80.

According to this embodiment, the diffusible hydrogen content in the product coil C obtained after the sound wave irradiation can be reduced to 0.5 mass ppm or less. As a result of the diffusible hydrogen content in the product coil C being reduced to 0.5 mass ppm or less, hydrogen embrittlement of the steel sheet can be prevented. The diffusible hydrogen content in the steel after the sound wave irradiation is preferably 0.3 mass ppm or less, and further preferably 0.2 mass ppm or less.

The diffusible hydrogen content in the product coil C is measured in the following manner: A test piece of 30 mm in length and 5 mm in width is collected from the ½ position in the radial direction of the product coil. In the case where the steel sheet is a hot-dip galvanized steel sheet or a galvannealed steel sheet, the hot-dip galvanized layer or the galvannealed layer of the test piece is removed by grinding or alkali. After this, the amount of hydrogen released from the test piece is measured by thermal desorption spectrometry (TDS). Specifically, the test piece is continuously heated from room temperature to 300° C. at a heating rate of 200° C./h and then cooled to room temperature, and the cumulative amount of hydrogen released from the test piece from room temperature to 210° C. is measured and taken to be the diffusible hydrogen content in the product coil C.

Application examples of this embodiment will be described in detail below.

[[Hot-Rolled Steel Sheet]]

The dehydrogenation apparatus 300a and the steel sheet production method according to this embodiment can be applied to the production of hot-rolled steel sheets.

A steel sheet production system according to this application example comprises: a hot rolling mill configured to subject a steel slab to hot rolling to obtain a hot-rolled steel sheet; a hot-rolled steel sheet coiler configured to coil the hot-rolled steel sheet to obtain a hot-rolled coil; and the steel sheet dehydrogenation apparatus configured to use the hot-rolled coil as the steel sheet coil C. The hot rolling mill subjects a steel slab having a known chemical composition to hot rolling including rough rolling and finish rolling, to obtain a hot-rolled steel sheet. The hot-rolled steel sheet coiler coils the hot-rolled steel sheet to obtain a hot-rolled coil. The dehydrogenation apparatus 300a irradiates the hot-rolled coil as the steel sheet coil C with sound waves under the foregoing conditions. As a result of the sound wave irradiation, the diffusible hydrogen content in the steel can be reduced and a hot-rolled steel sheet excellent in hydrogen embrittlement resistance can be obtained. The obtained hot-rolled steel sheet may be further subjected to cold rolling to obtain a cold-rolled steel sheet.

A steel sheet production method according to this application example comprises: a step of subjecting a steel slab to hot rolling to obtain a hot-rolled steel sheet; and a step of coiling the hot-rolled steel sheet to obtain a hot-rolled coil, wherein the hot-rolled coil is the steel sheet coil. The hot-rolled coil production method before sound wave irradiation is not limited, and a steel slab having a known chemical composition may be subjected to hot rolling including rough rolling and finish rolling to obtain a hot-rolled steel sheet, and the hot-rolled steel sheet may be coiled according to a known method to obtain a hot-rolled coil. As a result of the hot-rolled coil being irradiated with sound waves under the foregoing conditions, the diffusible hydrogen content in the steel can be reduced and a hot-rolled steel sheet excellent in hydrogen embrittlement resistance can be obtained. The obtained hot-rolled steel sheet may be further subjected to cold rolling to obtain a cold-rolled steel sheet.

[[Cold-Rolled Steel Sheet]]

The dehydrogenation apparatus 300a and the steel sheet production method according to this embodiment can also be applied to the production of cold-rolled steel sheets.

A steel sheet production system according to this application example comprises: a cold rolling mill configured to subject a hot-rolled steel sheet to cold rolling to obtain a cold-rolled steel sheet; a cold-rolled steel sheet coiler configured to coil the cold-rolled steel sheet to obtain a cold-rolled coil; and the dehydrogenation apparatus 300a configured to use the cold-rolled coil as the steel sheet coil C. The cold rolling mill subjects a known hot-rolled steel sheet optionally to hot-rolled sheet annealing, and subjects the hot-rolled steel sheet after the hot rolling or after the hot-rolled sheet annealing to cold rolling once, or twice or more with intermediate annealing being performed therebetween, to obtain a cold-rolled steel sheet having a final thickness. The cold-rolled steel sheet coiler coils the cold-rolled steel sheet after the cold rolling to obtain a cold-rolled coil by a known method. The dehydrogenation apparatus 300a irradiates the cold-rolled coil as the steel sheet coil C with sound waves under the foregoing conditions. As a result of the sound wave irradiation, the diffusible hydrogen content in the steel can be reduced and a cold-rolled steel sheet excellent in hydrogen embrittlement resistance can be obtained. The steel sheet production system may further comprise the dehydrogenation apparatus 300a configured to irradiate a hot-rolled coil obtained by coiling the hot-rolled steel sheet after the hot rolling with sound waves under the foregoing conditions. The hot-rolled coil after the sound wave irradiation is then uncoiled to feed the hot-rolled steel sheet, the hot-rolled steel sheet is subjected to cold rolling to obtain a cold-rolled coil, and the cold-rolled coil is irradiated with sound waves by the dehydrogenation apparatus 300a. Thus, the diffusible hydrogen content in the steel can be further reduced, and a steel sheet particularly excellent in hydrogen embrittlement resistance can be obtained.

A steel sheet production method according to this application example comprises: a step of subjecting a hot-rolled steel sheet to cold rolling to obtain a cold-rolled steel sheet; and a step of coiling the cold-rolled steel sheet to obtain a cold-rolled coil, wherein the cold-rolled coil is the steel sheet coil. The cold-rolled coil production method before sound wave irradiation is not limited. For example, a steel slab having a known chemical composition is subjected to hot rolling including rough rolling and finish rolling to obtain a hot-rolled steel sheet, and the hot-rolled steel sheet is optionally subjected to hot-rolled sheet annealing and then the hot-rolled steel sheet after the hot rolling or after the hot-rolled sheet annealing is subjected to cold rolling once, or twice or more with intermediate annealing being performed therebetween, to obtain a cold-rolled steel sheet having a final thickness. The cold-rolled steel sheet after the cold rolling is coiled to obtain a cold-rolled coil by a known method. As a result of the cold-rolled coil being irradiated with sound waves under the foregoing conditions, the diffusible hydrogen content in the steel can be reduced and a cold-rolled steel sheet excellent in hydrogen embrittlement resistance can be obtained. In addition to irradiating the cold-rolled coil with sound waves, the hot-rolled steel sheet after the hot rolling may be coiled to obtain a hot-rolled coil and the hot-rolled coil may be irradiated with sound waves under the foregoing conditions. The hot-rolled coil after the sound wave irradiation is then uncoiled to feed the hot-rolled steel sheet, the hot-rolled steel sheet is subjected to cold rolling to obtain a cold-rolled coil, and the cold-rolled coil is irradiated with sound waves. Thus, the diffusible hydrogen content in the steel can be further reduced, and a steel sheet particularly excellent in hydrogen embrittlement resistance can be obtained.

In this embodiment, the type of the hot-rolled steel sheet or the cold-rolled steel sheet irradiated with sound waves is not limited. Although the chemical composition of the steel sheet is not limited, for example, a steel sheet having the following chemical composition is particularly suitable for the application of the embodiment. The appropriate range of the chemical composition of the steel sheet and the reasons for limiting the chemical composition to such range will be described below.

[Essential Components]

C: 0.030% or more and 0.800% or less

C is an element necessary for increasing the strength. If the C content is 0.030% or more, particularly suitable strength can be obtained. If the C content is 0.800% or less, embrittlement of the material itself can be prevented particularly suitably. In view of this, the C content is preferably 0.030% or more. The C content is preferably 0.800% or less. The C content is more preferably 0.080% or more. The C content is more preferably 0.500% or less.

Si: 0.01% or more and 3.00% or less

Si is a solid-solution-strengthening element that forms a substitutional solid solution and greatly hardens the material, and is effective in increasing the strength of the steel sheet. To achieve the strength increasing effect by the addition of Si, the Si content is preferably 0.01% or more. From the viewpoint of preventing embrittlement and a ductility decrease of the steel and further preventing red scale and the like to obtain favorable surface characteristics and achieve favorable coating appearance and coating adhesion, the Si content is preferably 3.00% or less. Therefore, the Si content is preferably 0.01% or more. The Si content is preferably 3.00% or less. The Si content is more preferably 0.10% or more. The Si content is more preferably 2.50% or less.

Mn: 0.01% or more and 10.00% or less

Mn increases the strength of the steel sheet by solid solution strengthening. To achieve this effect, the Mn content is preferably 0.01% or more. If the Mn content is 10.00% or less, the segregation of Mn can be appropriately prevented to prevent the steel microstructure from being nonuniform, thus further suppressing hydrogen embrittlement. Therefore, the Mn content is 10.00% or less. The Mn content is more preferably 0.5% or more. The Mn content is more preferably 8.00% or less.

P: 0.001% or more and 0.100% or less

P is an element that has a solid solution strengthening action and can be added depending on the desired strength. To achieve this effect, the P content is preferably 0.001% or more. If the P content is 0.100% or less, excellent weldability can be achieved. If the P content is 0.100% or less, in the case of forming a galvanized coating or plating on the steel sheet surface and subjecting the galvanized coating or plating to an alloying treatment to form a galvannealed coating, a galvanized coating or plating of excellent quality can be formed without a decrease in alloying rate. Therefore, the P content is preferably 0.001% or more. The P content is preferably 0.100% or less. The P content is more preferably 0.003% or more. The P content is more preferably 0.050% or less.

S: 0.0001% or more and 0.0200% or less

By reducing the S content, it is possible to appropriately prevent the embrittlement of the steel in hot working and appropriately prevent the formation of sulfide to improve the local deformability. The S content is therefore preferably 0.0200% or less, more preferably 0.0100% or less, and further preferably 0.0050% or less. No lower limit is placed on the S content, but the S content is preferably 0.0001% or more under manufacturing constraints.

N: 0.0005% or more and 0.0100% or less

By reducing the N content, it is possible to improve the aging resistance of the steel. The N content is therefore preferably 0.0100% or less, and more preferably 0.0070% or less. No lower limit is placed on the N content, but the N content is preferably 0.0005% or more and more preferably 0.0010% or more under manufacturing constraints.

Al: 2.000% or less

Al is an element that acts as a deoxidizer and is effective for the cleanliness of the steel, and is preferably added in a deoxidation step. In the case of adding Al, to achieve the effect of adding Al, the Al content is preferably 0.001% or more. From the viewpoint of appropriately preventing slab cracking in continuous casting, the Al content is preferably 2.000% or less. The Al content is more preferably 0.010% or more. The Al content is more preferably 1.200% or less.

[Optional Components]

The chemical composition may further contain, in mass %, at least one element selected from the group consisting of Ti: 0.200% or less, Nb: 0.200% or less, V: 0.500% or less, W: 0.500% or less, B: 0.0050% or less, Ni: 1.000% or less, Cr: 1.000% or less, Mo: 1.000% or less, Cu: 1.000% or less, Sn: 0.200% or less, Sb: 0.200% or less, Ta: 0.100% or less, Ca: 0.0050% or less, Mg: 0.0050% or less, Zr: 0.0050% or less, and REM: 0.0050% or less.

Ti: 0.200% or less

Ti contributes to higher strength of the steel sheet by strengthening the steel by precipitation or by grain refinement strengthening through growth inhibition of ferrite crystal grains. In the case of adding Ti, the Ti content is preferably 0.005% or more. In the case of adding Ti, the Ti content is more preferably 0.010% or more. If the Ti content is 0.200% or less, precipitation of carbonitride can be appropriately prevented and the formability can be further improved. Accordingly, in the case of adding Ti, the Ti content is preferably 0.200% or less. The Ti content is more preferably 0.100% or less.

Nb: 0.200% or less, V: 0.500% or less, W: 0.500% or less

Nb, V, and W are effective in strengthening the steel by precipitation. Accordingly, in the case of adding any of Nb, V, and W, the content of each element is preferably 0.005% or more. In the case of adding any of Nb, V, and W, the content of each element is more preferably 0.010% or more. If the Nb content is 0.200% or less or if the content of each of V and W is 0.500% or less, precipitation of carbonitride can be appropriately prevented and the formability can be further improved, as with Ti. Accordingly, in the case of adding Nb, the Nb content is preferably 0.200% or less, and more preferably 0.100% or less. In the case of adding any of V and W, the content of each of V and W is preferably 0.500% or less, and more preferably 0.300% or less.

B: 0.0050% or less

B is effective in strengthening grain boundaries and strengthening the steel sheet. In the case of adding B, the B content is preferably 0.0003% or more. To achieve better formability, the B content is preferably 0.0050% or less. Accordingly, in the case of adding B, the B content is preferably 0.0050% or less, and more preferably 0.0030% or less.

Ni: 1.000% or less

Ni is an element that increases the strength of the steel by solid solution strengthening. In the case of adding Ni, the Ni content is preferably 0.005% or more. From the viewpoint of reducing the area ratio of hard martensite and further improving the ductility, the Ni content is preferably 1.000% or less. Accordingly, in the case of adding Ni, the Ni content is preferably 1.000% or less, and more preferably 0.500% or less.

Cr: 1.000% or less, Mo: 1.000% or less

Cr and Mo have an action of improving the balance between the strength and the formability, and may be optionally added. In the case of adding any of Cr and Mo, the content of each element is preferably 0.005% or more. From the viewpoint of reducing the area ratio of hard martensite and further improving the ductility, the content of each element is preferably 1.000% or less. The content of each element is more preferably 0.500% or less.

Cu: 1.000% or less

Cu is an element effective in strengthening the steel, and may be optionally added. In the case of adding Cu, the Cu content is preferably 0.005% or more. In the case of adding Cu, the Cu content is preferably 1.000% or less and more preferably 0.200% or less, from the viewpoint of reducing the area ratio of hard martensite and further improving the ductility.

Sn: 0.200% or less, Sb: 0.200% or less

Sn and Sb suppress decarburization of regions of about several tens of μm of the steel sheet surface layer caused by nitridization or oxidation of the steel sheet surface, and thus are effective in ensuring the strength and the material stability when optionally added. In the case of adding any of Sn and Sb, the content of each element is preferably 0.002% or more. In the case of adding any of Sn and Sb, the content of each element is preferably 0.200% or less and more preferably 0.050% or less, in order to further improve the toughness.

Ta: 0.100% or less

Ta forms alloy carbide and alloy carbonitride and contributes to higher strength, as with Ti and Nb. Ta is also considered to have an effect of, by partially dissolving in Nb carbide and Nb carbonitride and forming composite precipitate such as (Nb, Ta)(C, N), significantly suppressing the coarsening of precipitate and stabilizing the contribution of precipitation to higher strength. It is thus preferable to add Ta. In the case of adding Ta, the Ta content is preferably 0.001% or more. Although no upper limit is placed on the Ta content, in the case of adding Ta, the Ta content is preferably 0.100% or less and more preferably 0.050% or less, from the viewpoint of cost reduction.

Ca: 0.0050% or less, Mg: 0.0050% or less, Zr: 0.0050% or less, REM: 0.0050% or less

Ca, Mg, Zr, and REM are elements effective for spheroidizing sulfide and improving the adverse effect of the sulfide on the formability. In the case of adding any of these elements, the content of each element is preferably 0.0005% or more. In the case of adding any of these elements, the content of each element is preferably 0.0050% or less and more preferably 0.0020% or less in order to appropriately prevent inclusions and the like from increasing and more appropriately prevent surface and internal defects, etc.

This embodiment can also be suitably applied to high strength steel sheets for which hydrogen embrittlement is particularly problematic. By irradiating the steel sheet coil C composed of a high strength steel sheet with sound waves by the dehydrogenation apparatus 300a or the steel sheet production method, the diffusible hydrogen content in the steel can be reduced and a high strength steel sheet excellent in hydrogen embrittlement resistance can be obtained. For example, the steel sheet produced in this embodiment may be a high strength steel sheet whose tensile strength is 590 MPa or more, more preferably 1180 MPa or more, and further preferably 1470 MPa or more. The tensile strength of the steel sheet is measured in accordance with JIS Z 2241 (2011). In high strength steel sheets, delayed fractures due to hydrogen embrittlement are often problematic. According to this embodiment, a high strength steel sheet excellent in hydrogen embrittlement resistance can be produced without impairing the tensile strength.

With the dehydrogenation apparatus and the steel sheet production method according to this embodiment, it is also possible to produce stainless steel excellent in hydrogen embrittlement resistance by irradiating known stainless steel with sound waves. The chemical composition in the case where the steel sheet is a stainless steel sheet and the reasons for limiting the chemical composition to such range will be described below.

[Essential Components]

C: 0.001% or more and 0.400% or less

C is an element essential for achieving high strength in the stainless steel. If the C content is more than 0.400%, however, C combines with Cr and precipitates as carbide during tempering in steel production, and the carbide causes degradation in the corrosion resistance and toughness of the steel. If the C content is less than 0.001%, sufficient strength cannot be obtained. If the C content is more than 0.400%, the degradation is significant. The C content is therefore 0.001% or more and 0.400% or less. The C content is preferably 0.005% or more. The C content is preferably 0.350% or less.

Si: 0.01% or more and 2.00% or less

Si is an element useful as a deoxidizer. This effect is achieved if the Si content is 0.01% or more. If the Si content is excessively high, Si dissolved in the steel decreases the workability of the steel. The upper limit of the Si content is therefore 2.00%. The Si content is preferably 0.05% or more. The Si content is preferably 1.8% or less.

Mn: 0.01% or more and 5.00% or less

Mn has an effect of increasing the strength of the steel. This effect is achieved if the Mn content is 0.01% or more. If the Mn content is more than 5.00%, the workability of the steel decreases. The upper limit of the Mn content is therefore 5.00% or less. The Mn content is preferably 0.05% or more. The Mn content is preferably 4.6% or less.

P: 0.001% or more and 0.100% or less

P is an element that promotes grain boundary fractures due to grain boundary segregation. Accordingly, the P content is desirably low. The upper limit of the P content is 0.100%. The P content is preferably 0.030% or less, and further preferably 0.020% or less. Although no lower limit is placed on the P content, the P content is 0.001% or more under manufacturing constraints.

S: 0.0001% or more and 0.0200% or less

S is an element that exists as a sulfide-based inclusion such as MnS and causes decreases in ductility, corrosion resistance, and the like. These adverse effects are particularly noticeable in the case where the S content is more than 0.0200%. Accordingly, the S content is desirably as low as possible, and the upper limit of the S content is 0.0200%. The S content is preferably 0.010% or less, and further preferably 0.005% or less. Although no lower limit is placed on the S content, the S content is 0.0001% or more under manufacturing constraints.

Cr: 9.0% or more and 28.0% or less

Cr is a basic element constituting stainless steel, and is an important element that develops the corrosion resistance. Considering the corrosion resistance in a harsh environment of 180° C. or more, if the Cr content is less than 9.0%, the corrosion resistance is insufficient, and if the Cr content is more than 28.0%, the effect is saturated and the economic efficiency is poor. The Cr content is therefore 9.0% or more and 28.0% or less. The Cr content is preferably 10.0% or more. The Cr content is preferably 25.0% or less.

Ni: 0.01% or more and 40.0% or less

Ni is an element that improves the corrosion resistance of the stainless steel. If the Ni content is less than 0.01%, the effect is insufficient. If the Ni content is excessively high, the stainless steel hardens and the formability degrades, and stress corrosion cracking tends to occur. The Ni content is therefore 0.01% or more and 40.0% or less. The Ni content is preferably 0.1% or more. The Ni content is preferably 30.0% or less.

N: 0.0005% or more and 0.500% or less

N is an element detrimental to improving the corrosion resistance of the stainless steel, but is also an austenite forming element. If the N content is more than 0.5%, N precipitates as nitride during heat treatment, causing degradation in the corrosion resistance and toughness of the stainless steel. The upper limit of the N content is therefore 0.500%, and preferably 0.20%.

Al: 3.000% or less

Al is added as a deoxidizing element, and also has an effect of suppressing exfoliation of oxide scale. If the Al content is more than 3.000%, the elongation decreases and the surface quality degrades. The upper limit of the Al content is therefore 3.000%. Although no lower limit is placed on the Al content, the Al content is preferably 0.001% or more, and more preferably 0.01% or more. The Al content is preferably 2.5% or less.

[Optional Components]

The chemical composition of the stainless steel may further contain, in mass %, at least one element selected from the group consisting of Ti: 0.500% or less, Nb: 0.500% or less, V: 0.500% or less, W: 2.000% or less, B: 0.0050% or less, Mo: 2.000% or less, Cu: 3.000% or less, Sn: 0.500% or less, Sb: 0.200% or less, Ta: 0.100% or less, Ca: 0.0050% or less, Mg: 0.0050% or less, Zr: 0.0050% or less, and REM: 0.0050% or less.

Ti: 0.500% or less

Ti is an element added to combine with C, N, and S and improve the corrosion resistance, the intergranular corrosion resistance, and the deep drawability. If the Ti content is more than 0.500%, solute Ti hardens the stainless steel and degrades the toughness. The upper limit of the Ti content is therefore 0.500%. Although no lower limit is placed on the Ti content, the Ti content is preferably 0.003% or more, and more preferably 0.005% or more. The Ti content is preferably 0.300% or less.

Nb: 0.500% or less

Nb is an element added to combine with C, N, and S and improve the corrosion resistance, the intergranular corrosion resistance, and the deep drawability, as with Ti. Nb also improves the workability and the high-temperature strength, and suppresses crevice corrosion and facilitates repassivation. Hence, Nb is optionally added. If the Nb content is excessively high, the stainless steel hardens and the formability degrades. The upper limit of the Nb content is therefore 0.500%. Although no lower limit is placed on the Nb content, the Nb content is preferably 0.003% or more, and more preferably 0.005% or more. The Nb content is preferably 0.300% or less.

V: 0.500% or less

V suppresses crevice corrosion, and accordingly is optionally added. If the V content is excessively high, the stainless steel hardens and the formability degrades. The upper limit of the V content is therefore 0.500%. Although no lower limit is placed on the V content, the V content is preferably 0.01% or more, and more preferably 0.03% or more. The V content is preferably 0.300% or less.

W: 2.000% or less

W contributes to improved corrosion resistance and high-temperature strength, and accordingly is optionally added. If the W content is more than 2.000%, the stainless steel hardens and the toughness degrades in steel sheet production, and the costs increase. The upper limit of the W content is therefore 2.000%. Although no lower limit is placed on the W content, the W content is preferably 0.050% or more, and more preferably 0.010% or more. The W content is preferably 1.500% or less.

B: 0.0050% or less

B is an element that segregates to grain boundaries to improve the secondary workability of the product. B is optionally added to prevent longitudinal cracking when performing secondary working on parts and also prevent cracking in winter. If the B content is excessively high, the workability and the corrosion resistance decrease. The upper limit of the B content is therefore 0.0050%. Although no lower limit is placed on the B content, the B content is preferably 0.0002% or more, and more preferably 0.0005% or more. The B content is preferably 0.0035% or less.

Mo: 2.000% or less

Mo is an element that improves the corrosion resistance and, in the case where the steel sheet has a crevice structure, suppresses crevice corrosion. If the Mo content is more than 2.0%, the formability degrades significantly. The upper limit of the Mo content is therefore 2.000%. Although no lower limit is placed on the Mo content, the Mo content is preferably 0.005% or more, and more preferably 0.010% or more. The Mo content is preferably 1.500% or less.

Cu: 3.000% or less

Cu is an austenite stabilizing element as with Ni and Mn, and is effective in crystal grain refinement by phase transformation. Cu also suppresses crevice corrosion and facilitates repassivation. Hence, Cu is optionally added. If the Cu content is excessively high, the stainless steel hardens and the toughness and the formability degrade. The upper limit of the Cu content is therefore 3.000%. Although no lower limit is placed on the Cu content, the Cu content is preferably 0.005% or more, and more preferably 0.010% or more. The Cu content is preferably 2.000% or less.

Sn: 0.500% or less

Sn contributes to improved corrosion resistance and high-temperature strength, and accordingly is optionally added. If the Sn content is more than 0.500%, slab cracking may occur in steel sheet production. The Sn content is therefore 0.500% or less. Although no lower limit is placed on the Sn content, the Sn content is preferably 0.002% or more, and more preferably 0.005% or more. The Sn content is preferably 0.300% or less.

Sb: 0.200% or less

Sb is an element that has an action of segregating to grain boundaries and increasing the high-temperature strength. If the Sb content is more than 0.200%, the segregation of Sb occurs, which causes cracking in welding. The upper limit of the Sb content is therefore 0.200%. Although no lower limit is placed on the Sb content, the Sb content is preferably 0.002% or more, and more preferably 0.005% or more. The Sb content is preferably 0.100% or less.

Ta: 0.100% or less

Ta combines with C and N and contributes to improved toughness, and accordingly is optionally added. If the Ta content is more than 0.100%, the effect is saturated, and the production costs increase. The upper limit of the Ta content is therefore 0.100%. Although no lower limit is placed on the Ta content, the Ta content is preferably 0.002% or more, and more preferably 0.005% or more. The Ta content is preferably 0.080% or less.

Ca: 0.0050% or less, Mg: 0.0050% or less, Zr: 0.0050% or less, REM (rare earth metal): 0.0050% or less

Ca, Mg, Zr, and REM are elements effective for spheroidizing sulfide and improving the adverse effect of the sulfide on the formability. In the case of adding any of these elements, the content of each element is preferably 0.0005% or more. If the content of each element is excessively high, inclusions and the like increase, as a result of which surface and internal defects may occur. Accordingly, in the case of adding any of these elements, the content of each element is 0.0050% or less. Although no lower limit is placed on the content of each element, the content of each element is preferably 0.0002% or more, and more preferably 0.0005% or more. The content of each element is preferably 0.0035% or less.

[[Annealing Line]]

[[Annealing Step]]

The foregoing cold-rolled steel sheet or hot-rolled steel sheet may be subjected to annealing. That is, the steel sheet production system may comprise an annealing line configured to anneal the cold-rolled steel sheet or hot-rolled steel sheet. The annealing timing is not limited. However, given that usually hydrogen enters into steel in an annealing step, the annealing is preferably performed before the sound wave irradiation in order to finally obtain a steel sheet excellent in hydrogen embrittlement resistance. The annealing line may be a batch annealing furnace or a continuous annealing line.

[Batch Annealing]

In the case of performing the annealing step using a batch annealing furnace, the steel sheet production system comprises: a batch annealing furnace configured to subject a cold-rolled coil or a hot-rolled coil to batch annealing to obtain an annealed coil; and the dehydrogenation apparatus 300a configured to use the annealed coil as the steel sheet coil C. The batch annealing furnace subjects the cold-rolled coil or the hot-rolled coil to batch annealing to obtain an annealed coil. Herein, “batch annealing” denotes heating and holding in a batch annealing furnace, and does not include slow cooling after the heating and holding. The annealed coil after the annealing is cooled by furnace cooling in the batch annealing furnace, air cooling, or the like. The dehydrogenation apparatus 300a irradiates the annealed coil as the steel sheet coil C with sound waves under the foregoing conditions. The dehydrogenation apparatus 300a may be provided separately from the batch annealing furnace. Alternatively, the housing 80 and the heater of the dehydrogenation apparatus 300a may also serve as the batch annealing furnace. In other words, the sound wave irradiator 60 that irradiates the steel sheet coil C housed in the batch annealing furnace with sound waves to obtain a product coil may be provided in the batch annealing furnace, as the dehydrogenation apparatus 300a. In the case where the housing 80 and the heater of the dehydrogenation apparatus 300a also serve as the batch annealing furnace, the sound wave irradiation may be performed after cooling the annealed coil to room temperature or while cooling the annealed coil, after the batch annealing. Diffusible hydrogen can be reduced more efficiently when the temperature of the steel sheet is higher, as mentioned above. Hence, although the sound wave irradiation may be performed after cooling the annealed coil to room temperature after the batch annealing, diffusible hydrogen in the steel can be reduced more efficiently by performing the sound wave irradiation while cooling the annealed coil after the batch annealing.

In the case of performing the annealing step using the batch annealing furnace, the steel sheet production method comprises a step of subjecting a cold-rolled coil or a hot-rolled coil obtained by coiling a cold-rolled steel sheet or a hot-rolled steel sheet to batch annealing to obtain an annealed coil, wherein the annealed coil as the steel sheet coil is irradiated with sound waves under the foregoing conditions. First, a cold-rolled steel sheet or a hot-rolled steel sheet is coiled to obtain a cold-rolled coil or a hot-rolled coil by a known method. Following this, the cold-rolled coil or the hot-rolled coil is placed in the batch annealing furnace, and subjected to batch annealing in the batch annealing furnace to obtain an annealed coil. The annealed coil after the annealing is cooled by furnace cooling in the batch annealing furnace, air cooling, or the like. The annealed coil is then irradiated with sound waves under the foregoing conditions. The sound wave irradiation for the annealed coil may be performed during the batch annealing, i.e. while heating and holding the cold-rolled coil or the hot-rolled coil. The sound wave irradiation may be performed after the batch annealing, i.e. after heating and holding the cold-rolled coil or the hot-rolled coil. The sound wave irradiation may be performed after cooling the annealed coil to room temperature or while cooling the annealed coil, after the batch annealing. Diffusible hydrogen can be reduced more efficiently when the temperature of the steel sheet is higher, as mentioned above. Hence, it is preferable to perform the sound wave irradiation during the batch annealing, or perform the sound wave irradiation on the annealed coil while cooling the annealed coil after the batch annealing. The sound wave irradiation for the annealed coil may be performed in the batch annealing furnace, or performed after taking out the annealed coil from the batch annealing furnace. Preferably, the annealed coil is irradiated with sound waves in the batch annealing furnace. As a result of the annealed coil being irradiated with sound waves in the batch annealing furnace, diffusible hydrogen in the steel can be reduced efficiently.

[Annealing by Continuous Annealing Line]

Annealing may be performed by passing a cold-rolled steel sheet or a hot-rolled steel sheet through a continuous annealing line (CAL). In the case of performing the annealing step using the continuous annealing line, the steel sheet production system comprises: a pre-annealing uncoiler configured to uncoil a cold-rolled coil or a hot-rolled coil to feed a cold-rolled steel sheet or a hot-rolled steel sheet, respectively; a continuous annealing furnace configured to subject the cold-rolled steel sheet or the hot-rolled steel sheet to continuous annealing to obtain an annealed steel sheet; an annealed steel sheet coiler configured to coil the annealed steel sheet to obtain an annealed coil; and the dehydrogenation apparatus 300a configured to use the annealed coil as the steel sheet coil C. The pre-annealing uncoiler uncoils a cold-rolled coil or a hot-rolled coil to feed a cold-rolled steel sheet or a hot-rolled steel sheet respectively, and supplies the cold-rolled steel sheet or the hot-rolled steel sheet to the CAL. The structure of the CAL is not limited. In one example, the CAL includes a continuous annealing furnace in which a heating zone, a soaking zone, and a cooling zone are arranged in this order. The cooling zone may be composed of a plurality of cooling zones. In such a case, the plurality of cooling zones may include a holding zone in which the cold-rolled steel strip in the cooling process is held in a certain temperature range and/or a reheating zone in which the steel sheet in the cooling process is reheated. A preheating zone may be provided upstream of the heating zone in the sheet passing direction. The pre-annealing uncoiler may be a payoff reel located upstream of the continuous annealing furnace in the CAL. The annealed steel sheet coiler may be a tension reel located downstream of the continuous annealing furnace in the CAL. In the CAL, (A) the cold-rolled coil or the hot-rolled coil is uncoiled to feed the cold-rolled steel sheet or the hot-rolled steel sheet respectively by the payoff reel, (B) the cold-rolled steel sheet or the hot-rolled steel sheet is passed through the continuous annealing furnace in which the heating zone, the soaking zone, and the cooling zone are arranged from the upstream side in the sheet passing direction to continuously anneal the cold-rolled steel sheet or the hot-rolled steel sheet by (B-1) annealing the cold-rolled steel sheet or the hot-rolled steel sheet to obtain an annealed steel sheet in the heating zone and the soaking zone and (B-2) cooling the annealed steel sheet in the cooling zone, (C) the annealed steel sheet discharged from the continuous annealing furnace is continuously passed, and (D) the steel sheet is coiled by the tension reel to obtain an annealed coil. The dehydrogenation apparatus 300a irradiates the annealed coil as the steel sheet coil C with sound waves under the foregoing conditions. As a result of the sound wave irradiation, the diffusible hydrogen content in the steel can be reduced and an annealed steel sheet excellent in hydrogen embrittlement resistance can be obtained. The cooling method and the cooling rate of the steel sheet in the cooling zone are not limited, and any cooling such as gas jet cooling, mist cooling, or water cooling may be used.

In the case of performing the annealing step using a continuous annealing line, the steel sheet production method comprises: a step of uncoiling a cold-rolled coil to feed a cold-rolled steel sheet; a step of continuously annealing the cold-rolled steel sheet to obtain an annealed steel sheet; and a step of coiling the annealed steel sheet to obtain an annealed coil, wherein the annealed coil is the steel sheet coil. In the CAL, (A) the steel sheet coil is uncoiled by the payoff reel, (B) the steel sheet is passed through the annealing furnace in which the heating zone, the soaking zone, and the cooling zone are arranged from the upstream side in the sheet passing direction to continuously anneal the steel sheet by (B-1) annealing the steel sheet in the heating zone and the soaking zone and (B-2) cooling the steel sheet in the cooling zone, (C) the steel sheet discharged from the annealing furnace is continuously passed, and (D) the steel sheet is coiled by the tension reel to obtain an annealed coil. As a result of the annealed coil being irradiated with sound waves under the foregoing conditions, a cold-rolled steel sheet or a hot-rolled steel sheet excellent in hydrogen embrittlement resistance can be obtained.

[[Coated or Plated Steel Sheet]]

The dehydrogenation apparatus 300a according to this embodiment can also be applied to the production of coated or plated steel sheets. A steel sheet production system according to this application example comprises: a coating or plating apparatus configured to form a coating or plating on a surface of a hot-rolled steel sheet or a cold-rolled steel sheet to obtain a coated or plated steel sheet; a coated or plated steel sheet coiler configured to coil the coated or plated steel sheet to obtain a coated or plated steel sheet coil; and the dehydrogenation apparatus 300a configured to use the coated or plated steel sheet coil as the steel sheet coil C. The coating or plating apparatus forms a coating or plating on the surface of a hot-rolled steel sheet or a cold-rolled steel sheet as a base steel sheet to obtain a coated or plated steel sheet. The coated or plated steel sheet coiler coils the coated or plated steel sheet to obtain a coated or plated steel sheet coil. The dehydrogenation apparatus 300a irradiates the coated or plated steel sheet coil as the steel sheet coil C with sound waves under the foregoing conditions. As a result of the sound wave irradiation, the diffusible hydrogen content in the steel can be reduced and a coated or plated steel sheet excellent in hydrogen embrittlement resistance can be obtained.

A coating or plating may be formed on the surface of a hot-rolled steel sheet or a cold-rolled steel sheet as a base steel sheet to obtain a coated or plated steel sheet, which is then used as a steel sheet coil irradiated with sound waves. In the case of irradiating a coated or plated steel sheet coil with sound waves, the steel sheet production method comprises: a step of forming a coating or plating on a surface of a hot-rolled steel sheet or a cold-rolled steel sheet to obtain a coated or plated steel sheet; and a step of coiling the coated or plated steel sheet to obtain a coated or plated steel sheet coil, wherein the coated or plated steel sheet coil is the steel sheet coil.

[Formation of Coating or Plating by Continuous Hot-Dip Galvanizing Line]

The type of the coating or plating apparatus is not limited. For example, the coating or plating apparatus may be a hot-dip galvanizing apparatus. In one example, the hot-dip galvanizing apparatus may be a continuous hot-dip galvanizing line (CGL). The structure of the CGL is not limited. In one example, the CGL includes: a continuous annealing furnace in which a heating zone, a soaking zone, and a cooling zone are arranged in this order; and a hot-dip galvanizing apparatus located downstream of the cooling zone. In the CGL, (A) the cold-rolled coil or the hot-rolled coil is uncoiled to feed the cold-rolled steel sheet or the hot-rolled steel sheet respectively by the payoff reel, (B) the cold-rolled steel sheet or the hot-rolled steel sheet is passed through the continuous annealing furnace in which the heating zone, the soaking zone, and the cooling zone are arranged from the upstream side in the sheet passing direction to continuously anneal the cold-rolled steel sheet or the hot-rolled steel sheet by (B-1) annealing the hot-rolled steel sheet or the cold-rolled steel sheet in a reducing atmosphere containing hydrogen to obtain an annealed steel sheet in the soaking zone and (B-2) cooling the annealed steel sheet in the cooling zone, (C) the annealed steel sheet discharged from the annealing furnace is continuously passed to (C-1) immerse the annealed steel sheet in a hot-dip galvanizing bath located downstream of the continuous annealing furnace in the sheet passing direction to subject the annealed steel sheet to a hot-dip galvanizing treatment and obtain a hot-dip galvanized steel sheet, and (D) the hot-dip galvanized steel sheet is coiled by the tension reel to obtain a hot-dip galvanized steel sheet coil. The dehydrogenation apparatus 300a irradiates the hot-dip galvanized steel sheet coil as the steel sheet coil C with sound waves under the foregoing conditions. As a result of the sound wave irradiation, the diffusible hydrogen content in the steel can be reduced and a hot-dip galvanized steel sheet excellent in hydrogen embrittlement resistance can be obtained.

The method of forming the coating or plating on the surface of the hot-rolled steel sheet or the cold-rolled steel sheet is not limited, and the coating or plating step may include a hot-dip galvanizing step. That is, the hot-rolled steel sheet or the cold-rolled steel sheet may be subjected to a hot-dip galvanizing treatment to obtain a hot-dip galvanized steel sheet. In one example, the steel sheet may be subjected to a hot-dip galvanizing treatment using a continuous hot-dip galvanizing line (CGL). In the CGL, (A) the steel sheet coil is uncoiled by the payoff reel, (B) the hot-rolled steel sheet or the cold-rolled steel sheet is passed through the annealing furnace in which the heating zone, the soaking zone, and the cooling zone are arranged from the upstream side in the sheet passing direction to continuously anneal the hot-rolled steel sheet or the cold-rolled steel sheet by (B-1) annealing the hot-rolled steel sheet or the cold-rolled steel sheet in a reducing atmosphere containing hydrogen to obtain an annealed steel sheet in the soaking zone and (B-2) cooling the annealed steel sheet in the cooling zone, (C) the annealed steel sheet discharged from the annealing furnace is continuously passed, and (D) the annealed steel sheet is coiled by the tension reel to obtain an annealed coil. The step (C) includes (C-1) immersing the annealed steel sheet in a hot-dip galvanizing bath located downstream of the annealing furnace in the sheet passing direction to subject the annealed steel sheet to a hot-dip galvanizing treatment. The annealed coil obtained by the coiling is a hot-dip galvanized steel sheet coil composed of a hot-dip galvanized steel sheet. As a result of the hot-dip galvanized steel sheet coil being irradiated with sound waves under the foregoing conditions, a hot-dip galvanized steel sheet excellent in hydrogen embrittlement resistance can be obtained.

The coating or plating apparatus may include a hot-dip galvanizing apparatus and an alloying furnace following the hot-dip galvanizing apparatus. In one example, after producing a hot-dip galvanized steel sheet using the CGL, i.e. after the foregoing step (C-1), (C-2) the steel sheet is passed through the alloying furnace located downstream of the hot-dip galvanizing bath in the sheet passing direction to heat and alloy the hot-dip galvanizing. A galvannealed steel sheet obtained by alloying in the alloying furnace is coiled into a galvannealed steel sheet coil. The dehydrogenation apparatus 300a irradiates the galvannealed steel sheet coil as the steel sheet coil C with sound waves under the foregoing conditions. As a result of the sound wave irradiation, a galvannealed steel sheet excellent in hydrogen embrittlement resistance can be obtained.

The coating or plating step may include a hot-dip galvanizing step and an alloying step following the hot-dip galvanizing step. That is, the hot-dip galvanized steel sheet may be further subjected to an alloying treatment to obtain a galvannealed steel sheet, which is then irradiated with sound waves. In one example, after producing a hot-dip galvanized steel sheet using the CGL, i.e. after the foregoing step (C-1), (C-2) the steel sheet is passed through the alloying furnace located downstream of the hot-dip galvanizing bath in the sheet passing direction to heat and alloy the hot-dip galvanizing. A galvannealed steel sheet obtained by alloying in the alloying furnace is coiled into a galvannealed steel sheet coil. As a result of the galvannealed steel sheet coil being irradiated with sound waves under the foregoing conditions, a galvannealed steel sheet excellent in hydrogen embrittlement resistance can be obtained.

The coating or plating apparatus is not limited to forming a galvanized coating or plating, and may form an Al coating or plating or a Fe coating or plating. The coating or plating apparatus is not limited to a hot-dip coating apparatus, and may be an electroplating apparatus.

The type of the coating or plating that can be formed on the surface of the steel sheet irradiated with sound waves is not limited, and may be an Al coating or plating or a Fe coating or plating. The method of forming the coating or plating is not limited to a hot-dip coating step, and may be an electroplating step.

The steel sheet production system may further comprise a skin pass rolling mill configured to subject the above-obtained hot-rolled steel sheet, cold-rolled steel sheet, or coated or plated steel sheet having any of various coatings or platings on the hot-rolled steel sheet or cold-rolled steel sheet to skin pass rolling for the purpose of shape adjustment, surface roughness adjustment, etc. That is, the steel sheet production method may subject the above-obtained hot-rolled steel sheet, cold-rolled steel sheet, or coated or plated steel sheet having any of various coatings or platings on the hot-rolled steel sheet or cold-rolled steel sheet to skin pass rolling for the purpose of shape adjustment, surface roughness adjustment, etc. The rolling reduction ratio of the skin pass rolling is preferably controlled to be 0.1% or more, and preferably controlled to be 2.0% or less. If the rolling reduction ratio of the skin pass rolling is 0.1% or more, the effect of shape adjustment and the effect of surface roughness adjustment can be enhanced, and the rolling reduction ratio can be easily controlled. If the rolling reduction ratio of the skin pass rolling is 2.0% or less, the productivity can be improved. The skin pass rolling mill may be continuous with the CGL or CAL (inline), or not continuous with the CGL or CAL (offline). Skin pass rolling of the target rolling reduction ratio may be performed at one time, or skin pass rolling may be performed several times to achieve the target rolling reduction ratio. The steel sheet production system may further comprise a coating apparatus configured to apply any of various coating treatments such as resin or oil coating to the surface of the above-obtained hot-rolled steel sheet, cold-rolled steel sheet, or coated or plated steel sheet having any of various coatings or platings on the hot-rolled steel sheet or cold-rolled steel sheet. That is, any of various coating treatments such as resin or oil coating may be applied to the surface of the above-obtained hot-rolled steel sheet, cold-rolled steel sheet, or coated or plated steel sheet having any of various coatings or platings on the hot-rolled steel sheet or cold-rolled steel sheet.

### Embodiment 2

A dehydrogenation apparatus according to Embodiment 2 of the present disclosure comprises: an uncoiler configured to uncoil a steel sheet coil to feed a steel strip; a sheet passing device configured to pass the steel strip therethrough; a coiler configured to coil the steel strip; and a sound wave irradiator configured to irradiate the steel strip being passed through the sheet passing device with sound waves to obtain a product coil.

A steel sheet production method according to Embodiment 2 of the present disclosure comprises: a step of uncoiling a steel sheet coil to feed a steel strip; a sheet passing step of passing the steel strip; and a step of coiling the steel strip to obtain a product coil, wherein the sheet passing step includes a sound wave irradiation step of irradiating the steel strip with sound waves so that a sound pressure at a surface of the steel strip will be 30 dB or more.

A steel sheet optionally subjected to annealing after hot rolling or cold rolling or a coated or plated steel sheet obtained by further forming a coating or plating on the steel sheet is coiled into a steel sheet coil. Since the mass of the steel sheet coil is often different from the packaging mass at the time of shipment, division by the packaging mass is performed in the recoiling line. The uncoiler uncoils the steel sheet coil to feed the steel strip, and the recoiler recoils the steel strip fed. Once the recoiled steel strip has reached a predetermined packaging mass, the steel strip is sheared and divided. In this embodiment, the steel strip uncoiled by this recoiling line is irradiated with sound waves. According to this embodiment, the steel strip being passed is irradiated with sound waves, so that the steel strip can be uniformly irradiated with sound waves throughout its length. The dehydrogenation apparatus according to this embodiment is an apparatus not continuous with the continuous annealing line or the continuous hot-dip galvanizing line (offline), and the dehydrogenation apparatus does not include a line for performing annealing, a coating or plating treatment, and a hot-dip galvanizing treatment on the steel strip.

[[Dehydrogenation Apparatus]]

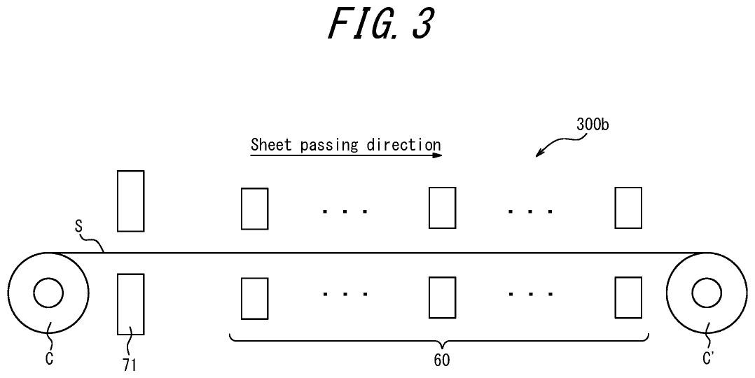

FIG. 3 is a view of a dehydrogenation apparatus 300b used in the steel sheet production method according to this embodiment, as seen in the transverse direction of a steel strip S. In the dehydrogenation apparatus 300b, sound wave irradiators 60 are arranged in the passage of the steel strip S fed as a result of uncoiling by the uncoiler, as illustrated in FIG. 3. In each sound wave irradiator 60, a horn 68, a booster 66, a vibration transducer 64, a sound wave oscillator 62, and a sound pressure controller 69 are connected in this order (not illustrated), and the steel strip S is irradiated with sound waves from the horn 68. The sound wave irradiators 60 may be provided only on one of the front and back sides of the steel strip S being passed, or provided on both of the front and back sides of the steel strip S being passed to vibrate the steel strip S, as illustrated in FIG. 3. By providing the sound wave irradiators 60 on both of the front and back sides of the steel strip S being passed, the sound wave irradiation timing can be controlled to reduce the diffusible hydrogen content in the steel more efficiently. The dehydrogenation apparatus 300b includes a sheet passing device (not illustrated) that passes the steel strip S from the uncoiler toward the coiler. The sheet passing device includes, for example, a sheet passing roll for passing the steel strip S toward the coiler.

A plurality of horns 68 are arranged in the steel strip transverse direction, with certain spacing from the surface of the steel strip S being passed. By irradiating the surface of the steel strip S being passed with sound waves from each horn 68, the surface can be uniformly irradiated with the sound waves in the transverse direction. The main traveling direction of the sound waves may be, for example, 45° or more, 60° or more, or 90° or more with respect to the surface of the steel strip S. By arranging, in the sheet passing direction, a plurality of horn groups each of which is made up of a plurality of horns 68 arranged in the steel strip transverse direction, the surface of the steel strip S can be exposed to sound waves for sufficient time.

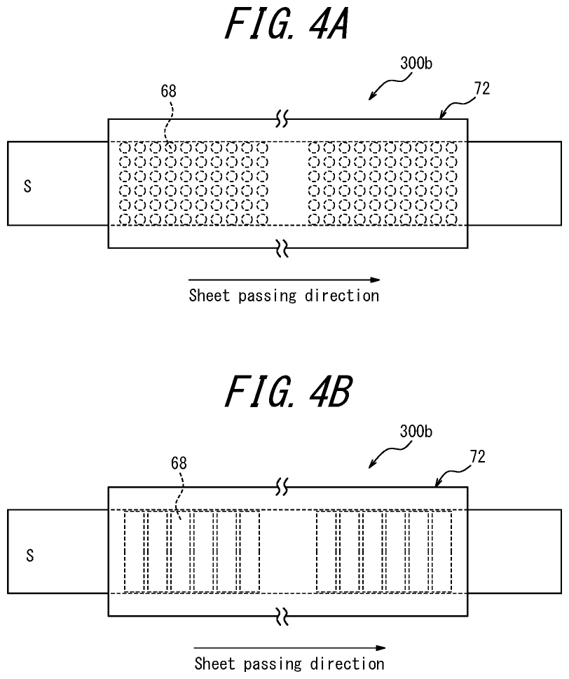

Examples of the arrangement of horns 68 will be described below, with reference to FIGS. 4A and 4B. FIGS. 4A and 4B are each a top view illustrating the arrangement of horns 68 with respect to the fed steel strip S in the dehydrogenation apparatus 300b according to this embodiment. As illustrated in FIG. 4A, a plurality of horns 68 may be arranged at uniform intervals in the transverse direction of the steel strip S and the sheet passing direction. The arrangement of horns 68 is not limited as long as the steel strip S being passed can be uniformly irradiated with sound waves, and a plurality of rectangular tube-shaped horns 68 each having a rectangular cross-sectional shape may be arranged in the sheet passing direction as illustrated in FIG. 4B. The configuration for holding the horns 68 at regular intervals in the dehydrogenation apparatus 300b is not limited. For example, a box-shaped portion 72 may be provided on the sheet path (i.e. the path through which the steel strip S is passed) so as to cover the steel strip S being passed, and the horns 68 may be fixed to the inner wall of the box-shaped portion 72 at regular intervals.

The structure of the sound wave irradiator 60 can be the same as that of in Embodiment 1. The frequency of sound waves can be the same as that in Embodiment 1.

[[Sound Pressure Level]]

As the sound pressure level, not the sound pressure level at the surface of the steel sheet coil but the sound pressure level at the surface of the steel strip is used. The sound pressure level can be adjusted in the same way as in Embodiment 1, except that the sound pressure level at the surface of the steel strip is measured by installing a sound pressure meter near the surface of the steel strip being passed and directly below the sound wave irradiator 60 or the sound pressure level at the surface of the steel strip is measured offline by determining the intensity I of the sound waves generated from the sound wave irradiator 60 and the distance D between the sound wave irradiator and the steel strip. In this embodiment, it is preferable to apply sound waves at a uniform sound pressure level in the steel sheet transverse direction, and the sound pressure level is preferably adjusted so that the minimum sound pressure level in a region inward from a steel sheet transverse edge by more than 5 mm will be 30 dB or more.

[[Irradiation Time]]

In the recoiling line, there is no need to adjust the sheet passing rate in view of the annealing time, unlike in the continuous annealing line or the continuous hot-dip galvanizing line. Hence, according to this embodiment, the steel strip can be irradiated with sound waves without any constraint on the irradiation time. Since a longer sound wave irradiation time is expected to contribute to reduction of more diffusible hydrogen, the sound wave irradiation time is preferably 1 minute or more. The sound wave irradiation time is more preferably 30 minutes or more, and further preferably 60 minutes or more. From the viewpoint of productivity, the sound wave irradiation time is preferably 30000 minutes or less, more preferably 10000 minutes or less, and further preferably 1000 minutes or less. The sound wave irradiation time can be adjusted based on the sheet passing rate of the steel strip S and the position of the sound wave irradiator (for example, the number of irradiator groups arranged in the sheet passing direction where each irradiator group is made up of a plurality of sound wave irradiators 60 arranged in the steel sheet transverse direction).

According to this embodiment, the diffusible hydrogen content in the product coil obtained after the sound wave irradiation can be reduced to 0.5 mass ppm or less. As a result of the diffusible hydrogen content in the product coil being reduced to 0.5 mass ppm or less, hydrogen embrittlement can be prevented. The diffusible hydrogen content in the steel after the sound wave irradiation is preferably 0.3 mass ppm or less, and further preferably 0.2 mass ppm or less. The diffusible hydrogen content in the steel after the sound wave irradiation can be measured in the same way as in Embodiment 1.

[[Heater]]

[[Holding Temperature of Steel Strip]]

As illustrated in FIG. 3, the dehydrogenation apparatus 300b may further comprise a heater 71 configured to heat the steel strip S at 300° C. or less while the steel strip S is irradiated with sound waves. The temperature of the steel strip S in the sound wave irradiation step is not limited. According to this embodiment, diffusible hydrogen in the steel can be reduced even without heating and holding the steel strip S. By irradiating the steel strip S with sound waves while heating the steel strip S by a heater, however, the hydrogen diffusion rate can be further increased, as a result of which the diffusible hydrogen content in the steel can be further reduced. Accordingly, the temperature of the steel strip S when applying sound waves is preferably 30° C. or more, more preferably 50° C. or more, and further preferably 100° C. or more. No upper limit is placed on the temperature of the steel strip S in the sound wave irradiation step, but the temperature of the steel strip S in the sound wave irradiation step is preferably 300° C. or less from the viewpoint of appropriately preventing the microstructural changes of the steel strip S. In this embodiment, the temperature of the steel strip S when applying sound waves is based on the temperature of the surface of the steel strip S. The surface temperature of the steel strip can be measured by a typical radiation thermometer. The arrangement of the heater 71 is not limited. For example, the heater 71 may be provided on the sheet path of the steel strip S, as illustrated in FIG. 3. By providing the heater 71 on the sheet path of the steel strip S, the steel strip S can be uniformly heated. In the case of providing the heater 71 on the sheet path of the steel strip S, the heater 71 is preferably located upstream of the sound wave irradiator 60 in the sheet path, as illustrated in FIG. 3. As a result of the heater 71 being located upstream of the sound wave irradiator 60 in the sheet path, the sufficiently heated steel strip S can be irradiated with sound waves. For example, the steel strip S can be irradiated with sound waves while heating and holding the steel strip S by a method of covering the steel sheet being passed with the foregoing box-shaped portion 72 and installing a heater on the side wall of the box-shaped portion 72. Moreover, the steel strip S can be irradiated with sound waves while heating and holding the steel strip S by a method of blowing high-temperature air generated outside to the box-shaped portion 72 and circulating it in the box-shaped portion 72. The heating method is not limited, and may be any of combustion heating and electric heating. In one example, the heater 71 may be an induction heater.

The dehydrogenation apparatus 300b according to this embodiment may further comprise a sound absorber configured to prevent the sound waves from leaking out of the dehydrogenation apparatus 300b. The specific structure of the sound absorber is not limited, but it is preferable to, for example, cover the steel strip S and the horn 68 with a sound absorber so as to contain the steel strip S and the horn 68 therein.

Application examples of this embodiment will be described in detail below.

[[Hot-Rolled Steel Sheet]]

The dehydrogenation apparatus 300b and the steel sheet production method according to this embodiment can be applied to the production of hot-rolled steel sheets, as in Embodiment 1.

A steel sheet production system according to this application example comprises: a hot rolling mill configured to subject a steel slab to hot rolling to obtain a hot-rolled steel sheet; a hot-rolled steel sheet coiler configured to coil the hot-rolled steel sheet to obtain a hot-rolled coil; and the dehydrogenation apparatus 300b configured to use the hot-rolled coil as the steel sheet coil. A hot-rolled coil produced by a known hot rolling mill is uncoiled to feed a hot-rolled steel sheet, the hot-rolled steel sheet is passed, and the hot-rolled steel sheet being passed is irradiated with sound waves under the foregoing conditions. As a result, the diffusible hydrogen content in the steel can be reduced and a hot-rolled steel sheet excellent in hydrogen embrittlement resistance can be obtained.

The steel sheet production method according to this embodiment can be applied to the production of hot-rolled steel sheets, as in Embodiment 1. A steel sheet production method according to this application example comprises: a step of subjecting a steel slab to hot rolling to obtain a hot-rolled steel sheet; and a step of coiling the hot-rolled steel sheet to obtain a hot-rolled coil, wherein the hot-rolled coil is the steel sheet coil. The hot-rolled coil production method before sound wave irradiation is not limited, and may be, for example, the production method described in Embodiment 1. The hot-rolled coil is uncoiled to feed a hot-rolled steel sheet, the hot-rolled steel sheet is passed, and the hot-rolled steel sheet being passed is irradiated with sound waves under the foregoing conditions. As a result, the diffusible hydrogen content in the steel can be reduced and a hot-rolled steel sheet excellent in hydrogen embrittlement resistance can be obtained.

[[Cold-Rolled Steel Sheet]]

The dehydrogenation apparatus 300b and the steel sheet production method according to this embodiment can also be applied to the production of cold-rolled steel sheets.

A steel sheet production system according to this application example comprises: a cold rolling mill configured to subject a hot-rolled steel sheet to cold rolling to obtain a cold-rolled steel sheet; a cold-rolled steel sheet coiler configured to coil the cold-rolled steel sheet to obtain a cold-rolled coil; and the dehydrogenation apparatus 300b configured to use the cold-rolled coil as the steel sheet coil C. A known cold rolling mill subjects a known hot-rolled steel sheet to cold rolling to obtain a cold-rolled steel sheet. The cold-rolled steel sheet coiler coils the cold-rolled steel sheet to obtain a cold-rolled coil. The cold-rolled coil as the steel sheet coil C is uncoiled to feed a cold-rolled steel sheet, the cold-rolled steel sheet is passed, and the cold-rolled steel sheet being passed is irradiated with sound waves under the foregoing conditions. As a result, the diffusible hydrogen content in the steel can be reduced and a cold-rolled steel sheet excellent in hydrogen embrittlement resistance can be obtained.

A steel sheet production method according to this application example comprises: a step of subjecting a hot-rolled steel sheet to cold rolling to obtain a cold-rolled steel sheet; and a step of coiling the cold-rolled steel sheet to obtain a cold-rolled coil, wherein the cold-rolled coil is the steel sheet coil. The cold-rolled coil production method before sound wave irradiation is not limited, and may be, for example, the production method described in Embodiment 1. The cold-rolled coil is uncoiled to feed a cold-rolled steel sheet, the cold-rolled steel sheet is passed, and the cold-rolled steel sheet being passed is irradiated with sound waves under the foregoing conditions. As a result, the diffusible hydrogen content in the steel can be reduced and a cold-rolled steel sheet excellent in hydrogen embrittlement resistance can be obtained.

The chemical composition of each of the hot-rolled steel sheet and the cold-rolled steel sheet irradiated with sound waves by the dehydrogenation apparatus 300b is not limited. However, according to this embodiment, by irradiating a high strength steel sheet whose tensile strength is 590 MPa or more, more preferably 1180 MPa or more, and further preferably 1470 MPa or more with sound waves by the dehydrogenation apparatus 300b, the diffusible hydrogen content in the steel can be reduced and a high strength steel sheet excellent in hydrogen embrittlement resistance can be obtained.

The chemical composition of each of the hot-rolled steel sheet and the cold-rolled steel sheet may be, for example, the chemical composition described in Embodiment 1.

[[Annealing Line]]

The steel sheet production system may comprise an annealing line configured to anneal the cold-rolled steel sheet or the hot-rolled steel sheet, as in Embodiment 1. The annealing timing is not limited. However, given that usually hydrogen enters into steel in an annealing step, the annealing is preferably performed before the sound wave irradiation in order to finally obtain a steel sheet excellent in hydrogen embrittlement resistance. The annealing line may be a batch annealing furnace or a continuous annealing line.

[[Annealing Step]]

The cold-rolled steel sheet or the hot-rolled steel sheet may be subjected to annealing, as in Embodiment 1. The annealing timing is not limited, but the annealing is preferably performed before the sound wave irradiation step. The annealing step may be performed using a batch annealing furnace or a continuous annealing line.

[Batch Annealing]

In the case of performing the annealing step using a batch annealing furnace, the steel sheet production system comprises: a batch annealing furnace configured to subject a cold-rolled coil or a hot-rolled coil to batch annealing to obtain an annealed coil; and the dehydrogenation apparatus 300b configured to use the annealed coil as the steel sheet coil C. The annealed coil after the annealing is cooled by furnace cooling in the batch annealing furnace, air cooling, or the like. The uncoiler uncoils the annealed coil to feed an annealed steel sheet to the sheet passing device, and the sheet passing device passes the annealed steel sheet. The sound wave irradiator 60 irradiates the annealed steel sheet being passed with sound waves under the foregoing conditions. As a result of the sound wave irradiation, the diffusible hydrogen content in the steel can be reduced and an annealed steel sheet excellent in hydrogen embrittlement resistance can be obtained.

In the case of performing the annealing step using the batch annealing furnace, the steel sheet production method comprises: a step of coiling a cold-rolled steel sheet or a hot-rolled steel sheet to obtain a cold-rolled coil or a hot-rolled coil; and a step of subjecting the cold-rolled coil or the hot-rolled coil to batch annealing to obtain an annealed coil, wherein the annealed coil is the steel sheet coil. The annealed coil after the annealing is cooled by furnace cooling in the batch annealing furnace, air cooling, or the like. Following this, the annealed coil is uncoiled to feed an annealed steel sheet, the annealed steel sheet is passed, and the annealed steel sheet being passed is irradiated with sound waves under the foregoing conditions. As a result, the diffusible hydrogen content in the steel can be reduced and an annealed steel sheet excellent in hydrogen embrittlement resistance can be obtained.

[Annealing by Continuous Annealing Line]

Annealing may be performed by passing a cold-rolled steel sheet or a hot-rolled steel sheet through a continuous annealing line (CAL). In the case of performing the annealing step using the continuous annealing line, the steel sheet production system comprises: a pre-annealing uncoiler configured to uncoil a cold-rolled coil or a hot-rolled coil to feed a cold-rolled steel sheet or a hot-rolled steel sheet, respectively; a continuous annealing furnace configured to subject the cold-rolled steel sheet or the hot-rolled steel sheet to continuous annealing to obtain an annealed steel sheet; an annealed steel sheet coiler configured to coil the annealed steel sheet to obtain an annealed coil; and the dehydrogenation apparatus 300b configured to use the annealed coil as the steel sheet coil C. The structure of the continuous annealing line is the same as that in Embodiment 1. In the dehydrogenation apparatus 300b, the uncoiler uncoils the annealed coil to feed an annealed steel sheet to the sheet passing device, and the sheet passing device passes the annealed steel sheet. The sound wave irradiator 60 irradiates the annealed steel sheet being passed with sound waves under the foregoing conditions. As a result of the sound wave irradiation, the diffusible hydrogen content in the steel can be reduced and an annealed steel sheet excellent in hydrogen embrittlement resistance can be obtained.

In the case of performing the annealing step using the continuous annealing line, the annealed coil before the sound wave irradiation can be produced in the same way as in Embodiment 1. The annealed coil is uncoiled to feed the annealed steel strip and the annealed steel sheet being passed is irradiated with sound waves under the foregoing conditions. As a result, an annealed steel sheet excellent in hydrogen embrittlement resistance can be obtained.

[[Coated or Plated Steel Sheet]]

The dehydrogenation apparatus 300b and the steel sheet production method according to this embodiment can also be applied to the production of coated or plated steel sheets, as in Embodiment 1.

A steel sheet production system according to this application example comprises: a coating or plating apparatus configured to form a coating or plating on a surface of a hot-rolled steel sheet or a cold-rolled steel sheet to obtain a coated or plated steel sheet; a coated or plated steel sheet coiler configured to coil the coated or plated steel sheet to obtain a coated or plated steel sheet coil; and the dehydrogenation apparatus 300b configured to use the coated or plated steel sheet coil as the steel sheet coil C. The type of the coating or plating that can be formed on the surface of the hot-rolled steel sheet or the cold-rolled steel sheet is not limited, and may be a galvanized coating or plating, an Al coating or plating, or a Fe coating or plating. The coating or plating method is not limited to a hot-dip coating step, and may be an electroplating step.

A steel sheet production method according to this application example comprises: a step of forming a coating or plating on a surface of a hot-rolled steel sheet or a cold-rolled steel sheet to obtain a coated or plated steel sheet; and a step of coiling the coated or plated steel sheet to obtain a coated or plated steel sheet coil, wherein the coated or plated steel sheet coil is the steel sheet coil.

[Formation of Coating or Plating by Continuous Hot-Dip Galvanizing Line]

The type of the coating or plating apparatus is not limited. For example, the coating or plating apparatus may be a hot-dip galvanizing apparatus. In one example, the hot-dip galvanizing apparatus may be a continuous hot-dip galvanizing line (CGL). The structure of the CGL may be the same as that in Embodiment 1. In the dehydrogenation apparatus 300b, the uncoiler uncoils the hot-dip galvanized steel sheet coil produced by the CGL to feed a hot-dip galvanized steel sheet to the sheet passing device, and the sheet passing device passes the hot-dip galvanized steel sheet. The sound wave irradiator 60 irradiates the annealed steel sheet being passed with sound waves under the foregoing conditions. As a result of the sound wave irradiation, the diffusible hydrogen content in the steel can be reduced and a hot-dip galvanized steel sheet excellent in hydrogen embrittlement resistance can be obtained.

The steel sheet before the sound wave irradiation may be subjected to a hot-dip galvanizing treatment to obtain a hot-dip galvanized steel sheet. In one example, the steel strip may be subjected to a hot-dip galvanizing treatment using a continuous hot-dip galvanizing line (CGL). The structure of the CGL may be the same as that in Embodiment 1. The hot-dip galvanized steel sheet coil before the sound wave irradiation can be produced in the same way as in Embodiment 1. The hot-dip galvanized steel sheet coil is uncoiled to feed the hot-dip galvanized steel sheet, the hot-dip galvanized steel sheet is passed, and the hot-dip galvanized steel sheet being passed is irradiated with sound waves under the foregoing conditions. As a result, a hot-dip galvanized steel sheet excellent in hydrogen embrittlement resistance can be obtained.

The coating or plating apparatus may include a hot-dip galvanizing apparatus and an alloying furnace following the hot-dip galvanizing apparatus. That is, in the steel sheet production method, the coating or plating step may include a hot-dip galvanizing step and an alloying step following the hot-dip galvanizing step. As the coating or plating apparatus including the alloying furnace, for example, the CGL including the alloying furnace downstream of the hot-dip galvanizing bath in the sheet passing direction in Embodiment 1 may be used. The galvannealed steel sheet coil produced by the hot-dip galvanizing step and the alloying step following the hot-dip galvanizing step is uncoiled to feed the galvannealed steel sheet, and the galvannealed steel sheet is irradiated with sound waves under the foregoing conditions. As a result, a galvannealed steel sheet excellent in hydrogen embrittlement resistance can be obtained.

The steel sheet production system may further comprise a skin pass rolling mill that subjects the above-obtained hot-rolled steel sheet, cold-rolled steel sheet, or coated or plated steel sheet having any of various coatings or platings on the hot-rolled steel sheet or cold-rolled steel sheet to skin pass rolling for the purpose of shape adjustment, surface roughness adjustment, etc., as in Embodiment 1. The steel sheet production system may further comprise a coating apparatus that applies any of various coating treatments such as resin or oil coating to the surface of the above-obtained hot-rolled steel sheet, cold-rolled steel sheet, or coated or plated steel sheet having any of various coatings or platings on the hot-rolled steel sheet or cold-rolled steel sheet.

That is, the steel sheet production method may subject the above-obtained hot-rolled steel sheet, cold-rolled steel sheet, or coated or plated steel sheet having any of various coatings or platings on the hot-rolled steel sheet or cold-rolled steel sheet to skin pass rolling, as in Embodiment 1. Moreover, any of various coating treatments such as resin or oil coating may be applied to the surface of the above-obtained hot-rolled steel sheet, cold-rolled steel sheet, or coated or plated steel sheet having any of various coatings or platings on the hot-rolled steel sheet or cold-rolled steel sheet.

### EXAMPLES

### First Example

Steels each having a chemical composition containing C: 0.09% or more and 0.37% or less, Si: 2.00% or less, Mn: 0.50% or more and 3.60% or less, P: 0.001% or more and 0.100% or less, S: 0.0200% or less, Al: 0.010% or more and 1.000% or less, and N: 0.0100% or less with the balance being Fe and inevitable impurities were each obtained by steelmaking using a converter, and continuously cast into a slab. The obtained slab was subjected to hot rolling and cold rolling to obtain a cold-rolled coil. As shown in Table 1, a steel sheet coil of a cold-rolled and annealed steel sheet (CR) was produced by a CAL or batch annealing in some examples, a steel sheet coil of a hot-dip galvanized steel sheet (GI) was produced by a CGL in some other examples, and a steel sheet coil of a galvannealed steel sheet (GA) was produced by the CGL in the remaining examples. The CR, the GI, and the GA were each 1.4 mm in thickness and 1000 mm in width. As the CAL, a CAL in which a heating zone, a soaking zone, and a cooling zone are arranged in this order was used. As the CGL, a CGL including: a continuous annealing furnace in which a heating zone, a soaking zone, and a cooling zone are arranged in this order; and a hot-dip galvanizing apparatus located downstream of the cooling zone was used. As the batch annealing furnace, a typical batch annealing furnace was used.

The obtained steel sheet coil of each of the CR, the GI, and the GA or a steel strip fed as a result of uncoiling the steel sheet coil was irradiated with sound waves. The sound wave irradiation was performed using the typical sound wave irradiator illustrated in FIG. 1, under the conditions of the sound pressure level, the frequency, and the irradiation time shown in Table 1. In Table 1, A denotes the case of irradiating a steel sheet coil with sound waves, and B denotes the case of irradiating a fed steel strip with sound waves. In the case of irradiating a steel sheet coil with sound waves, the dehydrogenation apparatus illustrated in FIGS. 2A to 2C was used. In the case of irradiating a steel strip with sound waves, the dehydrogenation apparatus illustrated in FIGS. 3 and 4A was used. As the horns, cylindrical horns were used. In the case of irradiating a steel sheet coil (outer diameter: 1500 mm, inner diameter: 610 mm, width: 1000 mm) with sound waves, the size of the housing was 2500 mm in height, 2000 mm in depth, and 2500 mm width, and the horns were arranged on the inner wall of the housing so as to surround the steel sheet coil. In the case of irradiating a steel strip being passed with sound waves, the horns were arranged on both of the front and back sides of the steel strip being passed. Six horns were arranged evenly in the steel strip transverse direction from a steel strip transverse edge. The height direction of the cylindrical horns was made parallel to the thickness direction of the steel strip so that the main traveling direction of the sound waves would be perpendicular to the surface of the steel strip. In Table 1, “room temperature” refers to approximately 25° C. The sound pressure level was adjusted by adjusting the intensity of the sound waves generated from the sound wave irradiator while fixing the position of the sound wave irradiator (i.e. the distance between the sound wave irradiator 60 and the steel strip S). In the case of irradiating a steel sheet coil with sound waves, the sound wave irradiation time was adjusted by adjusting the drive time of the sound wave irradiator. In the case of irradiating a fed steel strip with sound waves, the sound wave irradiation time was adjusted by adjusting the sheet passing rate of the steel strip. In the case of irradiating a fed steel strip with sound waves, the minimum sound pressure level in a region inward from a steel sheet transverse edge by more than 5 mm was 30 dB or more.

For each steel sheet before and after the sound wave irradiation, the tensile property, the diffusible hydrogen content in steel, the stretch flangeability, and the bendability were evaluated by the following methods. The results are shown in Table 1.

A tensile test was conducted in accordance with JIS Z 2241 (2011). A JIS No. 5 test piece was collected from each steel sheet after the sound wave irradiation so that the tensile direction would be perpendicular to the rolling direction of the steel sheet. Using the test piece, the tensile test was conducted under the conditions of a crosshead displacement rate of 1.67×10⁻¹ mm/s, and TS (tensile strength) was measured.

The stretch flangeability was evaluated by a hole expanding test. The hole expanding test was conducted in accordance with JIS Z 2256. A sample of 100 mm×100 mm was collected from the obtained steel sheet by shearing. A hole with a diameter of 10 mm was drilled through the sample with clearance 12.5%. In a state in which the periphery of the hole was clamped using a die having an inner diameter of 75 mm with a blank holding force of 9 tons (88.26 kN), a conical punch with an apical angle of 60° was pushed into the hole, and the hole diameter at crack initiation limit was measured. The maximum hole expansion ratio λ (%) was calculated using the following equation (4), and the hole expansion formability was evaluated from the maximum hole expansion ratio.

Maximum hole expansion ratio: λ (%)={(D_{f}−D₀)/D₀}×100 (4)

where D_{f} is the hole diameter at the time of occurrence of cracking (mm), and D₀ is the initial hole diameter (mm). In the case where the value of λ was 20% or more, the stretch flangeability was determined as favorable regardless of the strength of the steel sheet.

A bend test was conducted in accordance with JIS Z 2248. A strip test piece of 30 mm in width and 100 mm in length was collected from the obtained steel sheet so that the axial direction of the bend test would be parallel to the rolling direction of the steel sheet. The bend test was then conducted by a V-block bend test with a bending angle of 90°, under the conditions of an indentation load of 100 kN and a pressing-holding time of 5 seconds. In the present disclosure, a 90° V bend test was conducted, the ridge line part of the bending apex was observed with a microscope (RH-2000 produced by HIROX Co., Ltd.) with 40 magnification, and the bending radius when cracks of 200 μm or more in crack length were no longer observed was taken to be the minimum bending radius (R). In the case where the value (R/t) obtained by dividing R by the thickness (t) was 5.0 or less, the result of the bend test was determined as favorable.

The diffusible hydrogen content in steel was measured by the foregoing method.

TABLE 1

| | | Sound wave irradiation | | | | | Steel sheet | | | | | |
|---|---|---|---|---|---|---|---|---|---|---|---|---|
| | | | | Maximum | | | | Hydrogen | | | | |
| | | | | sound | Irra- | | | content in | | | | |
| | | State of | Fre- | pressure | diation | Irradiation | | steel sheet | | | | |
| | Steel sheet | steel | quency | level | time | temperature | | (mass | TS | λ | | |
| No. | production line | sheet¹⁾ | (Hz) | (dB) | (s) | (° C.) | Type²⁾ | ppm) | (MPa) | (%) | R/t | Remarks |
| 1 | Continuous annealing | A | 1000 | 120 | 30 | Room temperature | CR | 0.32 | 1472 | 35 | 2.8 | Example |
| 2 | Continuous annealing | A | 1000 | 100 | 3600 | Room temperature | CR | 0.11 | 1508 | 46 | 1.8 | Example |
| 3 | Continuous annealing | B | 1000 | 100 | 180 | Room temperature | CR | 0.15 | 1511 | 45 | 1.9 | Example |
| 4 | Continuous annealing | A | 1200 | 100 | 1800 | 100 | CR | 0.13 | 1526 | 40 | 1.7 | Example |
| 5 | Continuous annealing | — | — | — | — | — | CR | 0.54 | 1511 | 15 | 5.4 | Comparative |
| | | | | | | | | | | | | Example |
| 6 | Batch annealing | A | 1000 | 100 | 3600 | Room temperature | CR | 0.10 | 1492 | 47 | 1.7 | Example |
| 7 | Batch annealing | B | 1000 | 100 | 180 | Room temperature | CR | 0.14 | 1512 | 43 | 2.0 | Example |
| 8 | Continuous galvanizing | A | 1000 | 100 | 3600 | Room temperature | GA | 0.26 | 1545 | 39 | 2.9 | Example |
| 9 | Continuous galvanizing | A | 1000 | 100 | 7200 | Room temperature | GA | 0.22 | 1510 | 41 | 2.4 | Example |
| 10 | Continuous galvanizing | A | 1000 | 100 | 3600 | Room temperature | GI | 0.32 | 1532 | 37 | 3.7 | Example |
| 11 | Continuous galvanizing | B | 1000 | 100 | 3600 | 100 | GA | 0.12 | 1545 | 43 | 2.1 | Example |
| 12 | Continuous galvanizing | B | 1000 | 100 | 20 | Room temperature | GA | 0.39 | 1479 | 35 | 4.5 | Example |
| 13 | Continuous galvanizing | B | 1000 | 100 | 180 | Room temperature | GI | 0.49 | 1496 | 21 | 5.1 | Example |
| 14 | Continuous galvanizing | B | 1000 | 120 | 180 | Room temperature | GA | 0.35 | 1545 | 33 | 4.1 | Example |
| 15 | Continuous galvanizing | B | 1000 | 35 | 180 | Room temperature | GA | 0.48 | 1546 | 22 | 4.9 | Example |
| 16 | Continuous galvanizing | B | 1000 | 65 | 180 | Room temperature | GA | 0.45 | 1541 | 26 | 4.7 | Example |
| 17 | Continuous galvanizing | B | 1000 | 130 | 180 | Room temperature | GA | 0.22 | 1547 | 41 | 3.5 | Example |
| 18 | Continuous galvanizing | B | 1000 | 120 | 180 | 50 | GA | 0.25 | 1542 | 39 | 3.6 | Example |
| 19 | Continuous galvanizing | B | 1000 | 120 | 180 | 200 | GA | 0.12 | 1501 | 45 | 2.7 | Example |
| 20 | Continuous galvanizing | B | 3000 | 120 | 180 | Room temperature | GA | 0.33 | 1543 | 36 | 3.9 | Example |
| 21 | Continuous galvanizing | — | 10000 | 120 | 180 | Room temperature | GA | 0.29 | 1551 | 38 | 3.6 | Example |
| 22 | Continuous galvanizing | — | — | — | — | — | GA | 0.72 | 1529 | 10 | 7.7 | Comparative |
| | | | | | | | | | | | | Example |
| 23 | Continuous galvanizing | — | — | — | — | — | GI | 0.87 | 1545 | 5 | 8.2 | Comparative |
| | | | | | | | | | | | | Example |

Underlines indicate outside the appropriate range according to the present disclosure.
¹⁾A: steel sheet coil, B: steel strip being passed
²⁾CR: cold-rolled steel sheet, GI: hot-dip galvanized steel sheet (without alloying treatment of galvanizing), GA: galvannealed steel sheet

As can be understood from Table 1, in each Example, the sound wave irradiation step was performed, so that a steel sheet having low hydrogen content and excellent in stretch flangeability (λ) and bendability (R/t) as indexes of hydrogen embrittlement resistance was able to be produced. In each Comparative Example, on the other hand, one or both of the stretch flangeability (λ) and the bendability (R/t) was poor.

### Second Example

Steel materials each having the chemical composition shown in Table 2 with the balance being Fe and inevitable impurities were each obtained by steelmaking using a converter, and continuously cast into a steel slab. The obtained steel slab was subjected to hot rolling and thereafter cold rolling, and further annealed to obtain a cold-rolled steel sheet (CR). Some cold-rolled steel sheets were each further subjected to a hot-dip galvanizing treatment to obtain a hot-dip galvanized steel sheet (GI). Some hot-dip galvanized steel sheets were each further subjected to an alloying treatment to obtain a galvannealed steel sheet (GA). The CR, the GI, and the GA were each 1.4 mm in thickness and 1000 mm in width.

Each of the obtained CR, GI, and GA was coiled to obtain a steel sheet coil. The steel sheet coil or a steel strip fed as a result of uncoiling the steel sheet coil was irradiated with sound waves. Sound waves of the frequency shown in Table 3 were applied at the sound pressure level shown in Table 3 measured at the steel sheet surface for the time shown in Table 3, while holding the temperature at a ½ position in the radial direction of the steel sheet coil or the surface temperature of the steel strip at the temperature shown in Table 3. As the sound wave irradiator, the typical irradiator shown in FIG. 1 was used. As the horns, cylindrical horns were used. In the case of irradiating a steel sheet coil with sound waves, the dehydrogenation apparatus illustrated in FIGS. 2A to 2C was used to apply the sound waves and obtain a product coil. In the case of irradiating a fed steel strip with sound waves, the dehydrogenation apparatus illustrated in FIGS. 3 and 4A was used, and the steel strip after the sound wave irradiation was coiled to obtain a product coil. In the case of irradiating a steel sheet coil (outer diameter: 1500 mm, inner diameter: 610 mm, width: 1000 mm) with sound waves, the size of the housing was 2500 mm in height, 2000 mm in depth, and 2500 mm width, and the horns were arranged on the inner wall of the housing so as to surround the steel sheet coil. In the case of irradiating a fed steel strip with sound waves, the horns were arranged on both of the front and back sides of the steel strip being passed. Six horns were arranged evenly in the steel strip transverse direction from a steel strip transverse edge. The height direction of the cylindrical horns was made parallel to the thickness direction of the steel strip so that the main traveling direction of the sound waves would be perpendicular to the surface of the steel strip. The sound pressure level was adjusted by adjusting the intensity of the sound waves generated from the sound wave irradiator while fixing the position of the sound wave irradiator (i.e. the distance between the sound wave irradiator 60 and the steel strip S). In the case of irradiating a steel sheet coil with sound waves, the sound wave irradiation time was adjusted by adjusting the drive time of the sound wave irradiator. In the case of irradiating a fed steel strip with sound waves, the sound wave irradiation time was adjusted by adjusting the sheet passing rate of the steel strip. In the case of irradiating a fed steel strip with sound waves, the minimum sound pressure level in a region inward from a steel sheet transverse edge by more than 5 mm was 30 dB or more. For each steel sheet before and after the sound wave irradiation, the tensile property and the hydrogen embrittlement resistance were evaluated by the following methods. The results are shown in Table 3.

A tensile test was conducted in accordance with JIS Z 2241 (2011) using a JIS No. 5 test piece cut out from a ½ position in the radial direction of the product coil so that the tensile direction would be perpendicular to the rolling direction of the steel sheet, and EL′ (total elongation) after the sound wave irradiation was measured. Here, EL′ was measured within 72 hours after the end of the annealing. TS (tensile strength) and EL when the hydrogen content in the steel was 0 mass ppm were measured by leaving a sample, which was obtained from the product coil in the above-described manner, in the air for a long time of 10 weeks or more to reduce hydrogen in the steel and, after determining that the hydrogen content in the steel had reached 0 mass ppm by TDS described above, conducting a tensile test. Moreover, a tensile test was conducted in accordance with JIS Z 2241 (2011) using a JIS No. 5 test piece collected from the steel sheet coil before the sound wave irradiation, and EL″ before the sound wave irradiation was measured.

The hydrogen embrittlement resistance was evaluated from the foregoing tensile test as follows: In the case where the value obtained by dividing EL′ in the steel sheet after the sound wave irradiation by EL when the hydrogen content in the steel of the same steel sheet was 0 mass ppm was 0.7 or more, the hydrogen embrittlement resistance was determined as favorable.

Further, the diffusible hydrogen content in the steel before and after the sound wave irradiation was measured by TDS. In the case of measuring the diffusible hydrogen content in the steel before the sound wave irradiation, a test piece was collected not from the product coil but from the steel sheet coil, and the diffusible hydrogen content was measured.

TABLE 2

| Steel | | | | | | | | | | | | |
|---|---|---|---|---|---|---|---|---|---|---|---|---|
| sample | Chemical composition (mass %) | | | | | | | | | | | |
| ID | C | Si | Mn | P | S | N | Al | Ti | Nb | V | W | B |
| A | 0.222 | 1.46 | 2.71 | 0.021 | 0.0023 | 0.0033 | 0.029 | — | — | — | — | — |
| B | 0.174 | 1.51 | 2.25 | 0.025 | 0.0024 | 0.0042 | 0.046 | — | — | — | — | — |
| C | 0.165 | 0.56 | 3.55 | 0.018 | 0.0020 | 0.0020 | 0.035 | 0.048 | — | — | — | — |
| D | 0.785 | 0.97 | 1.30 | 0.030 | 0.0028 | 0.0025 | 0.058 | — | — | — | — | — |
| E | 0.048 | 1.00 | 3.09 | 0.032 | 0.0025 | 0.0027 | 0.031 | — | — | — | — | — |
| F | 0.170 | 2.90 | 3.21 | 0.028 | 0.0019 | 0.0027 | 0.031 | 0.023 | — | — | — | — |
| G | 0.423 | 0.60 | 1.11 | 0.031 | 0.0021 | 0.0036 | 0.040 | — | — | — | — | — |
| H | 0.071 | 1.02 | 5.02 | 0.027 | 0.0028 | 0.0031 | 0.044 | — | — | — | — | — |
| I | 0.241 | 2.03 | 2.85 | 0.021 | 0.0021 | 0.0025 | 0.034 | — | — | — | — | — |
| J | 0.149 | 0.21 | 3.44 | 0.028 | 0.0024 | 0.0036 | 0.031 | 0.013 | — | — | — | — |
| K | 0.115 | 0.35 | 6.99 | 0.025 | 0.0026 | 0.0032 | 0.029 | 0.051 | — | — | — | — |
| L | 0.338 | 0.46 | 0.62 | 0.021 | 0.0025 | 0.0029 | 0.033 | — | — | — | — | — |
| M | 0.165 | 0.34 | 1.88 | 0.021 | 0.0029 | 0.0029 | 1.053 | 0.045 | — | — | — | — |
| N | 0.190 | 0.34 | 1.81 | 0.027 | 0.0028 | 0.0043 | 0.045 | — | — | — | — | — |
| O | 0.150 | 0.74 | 3.42 | 0.020 | 0.0023 | 0.0039 | 0.041 | — | 0.051 | — | — | — |
| P | 0.130 | 0.50 | 2.52 | 0.030 | 0.0026 | 0.0039 | 0.045 | 0.020 | 0.040 | — | — | — |
| Q | 0.110 | 1.11 | 2.53 | 0.030 | 0.0024 | 0.0028 | 0.045 | 0.089 | — | 0.058 | — | — |
| R | 0.091 | 1.2 | 4.08 | 0.027 | 0.0027 | 0.0033 | 0.044 | — | — | — | 0.020 | — |
| S | 0.272 | 0.92 | 3.00 | 0.030 | 0.0023 | 0.0044 | 0.041 | 0.020 | — | — | — | 0.0021 |
| T | 0.179 | 0.68 | 6.4 | 0.026 | 0.0024 | 0.0039 | 0.014 | 0.102 | — | — | — | — |
| U | 0.098 | 0.15 | 2.31 | 0.021 | 0.0026 | 0.0036 | 0.058 | — | — | — | — | — |
| V | 0.110 | 1.41 | 3.07 | 0.030 | 0.0026 | 0.0033 | 0.031 | 0.032 | — | — | — | — |
| W | 0.164 | 1.51 | 2.74 | 0.026 | 0.0024 | 0.0027 | 0.041 | — | — | — | — | — |
| X | 0.129 | 0.57 | 3.16 | 0.025 | 0.0019 | 0.0032 | 0.036 | 0.041 | — | — | — | — |
| Y | 0.160 | 0.44 | 1.98 | 0.021 | 0.0021 | 0.0026 | 0.033 | 0.025 | — | — | — | — |
| Z | 0.143 | 0.68 | 3.57 | 0.018 | 0.0020 | 0.0030 | 0.029 | — | — | — | — | — |
| AA | 0.230 | 1.51 | 2.74 | 0.024 | 0.0026 | 0.0039 | 0.040 | — | — | — | — | — |
| AB | 0.172 | 0.96 | 2.81 | 0.021 | 0.0025 | 0.0037 | 0.035 | — | — | — | — | — |
| AC | 0.133 | 0.02 | 3.02 | 0.027 | 0.0023 | 0.0028 | 0.039 | 0.008 | — | — | — | — |
| AD | 0.069 | 0.06 | 7.13 | 0.022 | 0.0028 | 0.0037 | 0.042 | — | — | — | — | — |
| AE | 0.061 | 0.62 | 1.09 | 0.030 | 0.0078 | 0.0360 | 0.033 | — | — | — | — | — |
| AF | 0.059 | 0.68 | 0.92 | 0.028 | 0.0064 | 0.0312 | 0.035 | — | — | — | — | — |
| AG | 0.102 | 0.76 | 0.89 | 0.024 | 0.0068 | 0.0324 | 0.038 | — | — | — | — | — |
| AH | 0.021 | 0.61 | 0.92 | 0.030 | 0.0150 | 0.0200 | 0.042 | 0.388 | — | — | — | — |
| A | 0.019 | 0.77 | 0.89 | 0.028 | 0.0152 | 0.0195 | 0.038 | 0.378 | — | — | — | — |
| AJ | 0.024 | 0.83 | 0.91 | 0.024 | 0.0136 | 0.0222 | 0.034 | 0.390 | 0.467 | — | — | — |
| Steel | | | | | | | | | | | | |
| sample | Chemical composition (mass %) | | | | | | | | | | | |
| ID | Ni | Cr | Mo | Cu | Sn | Sb | Ta | Ca | Mg | Zr | REM | Remarks |
| A | — | — | — | — | — | — | — | — | — | — | — | Disclosed steel |
| B | — | — | — | — | — | — | — | — | — | — | — | Disclosed steel |
| C | — | — | — | — | — | — | — | — | — | — | — | Disclosed steel |
| D | — | — | — | — | — | — | — | — | — | — | — | Disclosed steel |
| E | — | — | — | — | — | — | — | — | — | — | — | Disclosed steel |
| F | — | — | — | — | — | — | — | — | — | — | — | Disclosed steel |
| G | — | — | — | — | — | — | — | — | — | — | — | Disclosed steel |
| H | — | — | — | — | — | — | — | — | — | — | — | Disclosed steel |
| I | — | — | — | — | — | — | — | — | — | — | — | Disclosed steel |
| J | — | — | — | — | — | — | — | — | — | — | — | Disclosed steel |
| K | — | — | — | — | — | — | — | — | — | — | — | Disclosed steel |
| L | — | — | — | — | — | — | — | — | — | — | — | Disclosed steel |
| M | — | — | — | — | — | — | — | — | — | — | — | Disclosed steel |
| N | — | — | — | — | — | — | — | — | — | — | — | Disclosed steel |
| O | — | — | — | — | — | — | — | — | — | — | — | Disclosed steel |
| P | — | — | — | — | — | — | — | — | — | — | — | Disclosed steel |
| Q | — | — | — | — | — | — | — | — | — | — | — | Disclosed steel |
| R | — | — | — | — | — | — | — | — | — | — | — | Disclosed steel |
| S | — | — | — | — | — | — | — | — | — | — | — | Disclosed steel |
| T | 0.125 | — | — | — | — | — | — | — | — | — | — | Disclosed steel |
| U | — | 0.599 | — | — | — | — | — | — | — | — | — | Disclosed steel |
| V | — | — | 0.060 | — | — | — | — | — | — | — | — | Disclosed steel |
| W | — | — | — | 0.114 | — | — | — | — | — | — | — | Disclosed steel |
| X | — | — | — | — | 0.005 | — | — | — | — | — | — | Disclosed steel |
| Y | — | — | — | — | — | 0.061 | — | — | — | — | — | Disclosed steel |
| Z | — | — | — | — | — | — | 0.008 | — | — | — | — | Disclosed steel |
| AA | — | — | — | — | — | — | — | 0.0040 | — | — | — | Disclosed steel |
| AB | — | — | — | — | — | — | — | — | 0.0032 | — | — | Disclosed steel |
| AC | — | — | — | — | — | — | — | — | — | 0.0035 | — | Disclosed steel |
| AD | — | — | — | — | — | — | — | — | — | — | 0.0028 | Disclosed steel |
| AE | 8.15 | 18.22 | — | — | — | — | — | — | — | — | — | Disclosed steel |
| AF | — | 16.31 | — | — | — | — | — | — | — | — | — | Disclosed steel |
| AG | — | 12.89 | — | — | — | — | — | — | — | — | — | Disclosed steel |
| AH | — | 21.14 | — | 0.423 | — | — | — | — | — | — | — | Disclosed steel |
| A | — | 23.01 | 0.551 | — | — | — | — | — | — | — | — | Disclosed steel |
| AJ | — | 22.48 | 0.924 | — | — | — | — | — | — | — | — | Disclosed steel |

Underlines indicate outside the range according to the present disclosure. Marks [—] indicate content of inevitable impurity level.

TABLE 3

| | | | | Steel | | | | | |
|---|---|---|---|---|---|---|---|---|---|
| | | | Sound | sheet | | | | EL″ | TS |
| | Steel | Sound wave | pressure | holding | Irradiation | Irradiation | | (before | (0 ppm |
| | sample | irradiation | level | temperature | frequency | time | | irradiation) | hydrogen) |
| No | ID | object | (dB) | (° C.) | (Hz) | (min) | Type¹⁾ | (%) | (MPa) |
| 1 | A | Steel sheet coil | 120 | 120 | 2500 | 600 | GA | 3.5 | 1510 |
| 2 | B | Steel strip | 95 | 180 | 1000 | 300 | GA | 11.7 | 1011 |
| 3 | C | Steel sheet coil | 100 | 300 | 8000 | 1200 | CR | 7.7 | 1008 |
| 4 | D | Steel sheet coil | 130 | 50 | 80000 | 6000 | GI | 1.2 | 2215 |
| 5 | E | Steel strip | 70 | 250 | 45000 | 600 | CR | 11.4 | 592 |
| 6 | F | Steel strip | 60 | 220 | 1250 | 3600 | CR | 6.3 | 1044 |
| 7 | G | Steel sheet coil | 40 | 140 | 5000 | 12000 | GI | 2.9 | 1822 |
| 8 | H | Steel sheet coil | 80 | 260 | 4000 | 5400 | GA | 4.1 | 1185 |
| 9 | I | Steel strip | 130 | 200 | 500 | 24000 | GI | 4.6 | 1523 |
| 10 | J | Steel strip | 100 | 240 | 1000 | 12000 | GA | 9.7 | 1010 |
| 11 | K | Steel sheet coil | 100 | 100 | 1500 | 600 | GI | 29.0 | 1044 |
| 12 | L | Steel strip | 120 | 160 | 1000 | 1200 | GA | 5.0 | 985 |
| 13 | M | Steel strip | 120 | 110 | 5000 | 900 | CR | 5.8 | 790 |
| 14 | N | Steel strip | 80 | 120 | 5000 | 600 | GI | 7.0 | 1332 |
| 15 | O | Steel strip | 90 | 190 | 5000 | 1200 | GI | 8.5 | 913 |
| 16 | P | Steel sheet coil | 100 | 100 | 4000 | 1200 | GA | 3.8 | 1280 |
| 17 | Q | Steel sheet coil | 120 | 140 | 30000 | 1200 | GI | 6.3 | 935 |
| 18 | R | Steel sheet coil | 120 | 50 | 50000 | 600 | CR | 6.7 | 1164 |
| 19 | S | Steel strip | 60 | 80 | 2000 | 120 | GA | 7.3 | 1490 |
| 20 | T | Steel sheet coil | 35 | 200 | 1250 | 20 | GI | 11.6 | 1009 |
| 21 | U | Steel strip | 80 | 80 | 1000 | 300 | GA | 4.7 | 1333 |
| 22 | V | Steel strip | 80 | 190 | 25000 | 600 | GA | 5.7 | 1312 |
| 23 | W | Steel sheet coil | 110 | 230 | 50000 | 60 | GA | 8.0 | 1220 |
| 24 | X | Steel strip | 110 | 220 | 8000 | 6000 | GI | 3.4 | 1480 |
| 25 | Y | Steel sheet coil | 120 | 150 | 10000 | 60 | GA | 4.0 | 1534 |
| 26 | Z | Steel strip | 120 | 240 | 500 | 1200 | CR | 3.3 | 1036 |
| 27 | AA | Steel strip | 90 | 70 | 1000 | 3000 | GA | 6.0 | 1550 |
| 28 | AB | Steel sheet coil | 100 | 200 | 1500 | 300 | CR | 12.7 | 1015 |
| 29 | AC | Steel strip | 50 | 210 | 2000 | 120 | GI | 5.5 | 1342 |
| 30 | AD | Steel sheet coil | 70 | 260 | 2000 | 15 | GA | 6.4 | 1319 |
| 31 | AE | Steel strip | 120 | 80 | 2000 | 600 | CR | 11.9 | 623 |
| 32 | AF | Steel strip | 120 | 150 | 1500 | 300 | CR | 8.0 | 611 |
| 33 | AG | Steel sheet coil | 120 | 130 | 1750 | 150 | CR | 6.0 | 605 |
| 34 | AH | Steel strip | 130 | 200 | 1350 | 7200 | CR | 5.6 | 591 |
| 35 | AI | Steel strip | 120 | 230 | 2500 | 900 | CR | 8.5 | 592 |
| 36 | AJ | Steel sheet coil | 100 | 100 | 12000 | 3600 | CR | 6.2 | 594 |
| 37 | A | Steel strip | 20 | 30 | 5000 | 3600 | CR | 4.4 | 1521 |
| 38 | A | Steel strip | 100 | −5 | 3000 | 2400 | GA | 9.8 | 1560 |
| 39 | A | Steel strip | 120 | 420 | 4000 | 60 | GA | 21.3 | 590 |
| 40 | A | Steel sheet coil | 130 | 200 | 5 | 120 | GA | 9.6 | 1560 |
| 41 | A | Steel sheet coil | 100 | 120 | 95000 | 300 | GA | 3.9 | 1613 |
| 42 | A | Steel strip | 100 | 260 | 120 | 180 | GI | 3.7 | 1508 |
| 43 | A | Steel strip | 120 | 60 | 75000 | 300 | GA | 4.0 | 1497 |
| 44 | A | Steel sheet coil | 100 | 220 | 5000 | 0.5 | GA | 9.3 | 1490 |
| 45 | A | Steel strip | 130 | 150 | 1250 | 28000 | GI | 2.0 | 1589 |

| | | | | Diffusible | Diffusible | |
|---|---|---|---|---|---|---|
| | | | | hydrogen | hydrogen | |
| | | | | content | content | |
| | EL | EL′ | Hydrogen | in steel | in steel | |
| | (0 ppm | (after | embrittlement | (before | (after | |
| | hydrogen) | irradiation) | resistance | irradiation) | irradiation) | |
| No | (%) | (%) | EL′/EL | (mass ppm) | (mass ppm) | Remarks |
| 1 | 9.5 | 9.3 | 0.98 | 0.62 | 0.11 | Example |
| 2 | 24.8 | 22.3 | 0.90 | 0.99 | 0.32 | Example |
| 3 | 26.0 | 24.2 | 0.93 | 0.84 | 0.10 | Example |
| 4 | 5.8 | 5.7 | 0.98 | 1.82 | 0.03 | Example |
| 5 | 25.8 | 21.2 | 0.82 | 0.59 | 0.20 | Example |
| 6 | 14.0 | 10.8 | 0.77 | 1.02 | 0.39 | Example |
| 7 | 8.1 | 5.8 | 0.72 | 1.43 | 0.43 | Example |
| 8 | 10.2 | 9.3 | 0.91 | 0.63 | 0.15 | Example |
| 9 | 21.0 | 20.9 | 1.00 | 1.00 | 0.02 | Example |
| 10 | 23.1 | 21.0 | 0.91 | 0.65 | 0.17 | Example |
| 11 | 45.1 | 33.4 | 0.74 | 0.57 | 0.45 | Example |
| 12 | 19.0 | 17.9 | 0.94 | 0.61 | 0.05 | Example |
| 13 | 24.0 | 23.9 | 1.00 | 0.72 | 0.03 | Example |
| 14 | 12.4 | 11.0 | 0.89 | 0.75 | 0.33 | Example |
| 15 | 24.8 | 20.1 | 0.81 | 1.20 | 0.27 | Example |
| 16 | 13.0 | 12.4 | 0.95 | 0.83 | 0.09 | Example |
| 17 | 29.7 | 28.1 | 0.95 | 0.79 | 0.02 | Example |
| 18 | 13.6 | 12.5 | 0.92 | 0.51 | 0.17 | Example |
| 19 | 12.5 | 10.6 | 0.85 | 0.73 | 0.36 | Example |
| 20 | 18.6 | 14.1 | 0.76 | 0.69 | 0.48 | Example |
| 21 | 12.8 | 11.9 | 0.93 | 0.82 | 0.16 | Example |
| 22 | 13.0 | 10.7 | 0.82 | 0.98 | 0.33 | Example |
| 23 | 16.9 | 14.8 | 0.88 | 0.56 | 0.19 | Example |
| 24 | 10.1 | 9.4 | 0.93 | 0.99 | 0.16 | Example |
| 25 | 12.6 | 12.1 | 0.96 | 0.52 | 0.07 | Example |
| 26 | 14.7 | 13.8 | 0.94 | 1.01 | 0.04 | Example |
| 27 | 16.3 | 15.1 | 0.93 | 0.71 | 0.14 | Example |
| 28 | 27.9 | 23.0 | 0.82 | 0.57 | 0.20 | Example |
| 29 | 15.0 | 13.9 | 0.93 | 0.52 | 0.10 | Example |
| 30 | 14.2 | 13.0 | 0.92 | 0.51 | 0.15 | Example |
| 31 | 48.5 | 48.3 | 1.00 | 0.66 | 0.03 | Example |
| 32 | 28.2 | 27.9 | 0.99 | 0.57 | 0.05 | Example |
| 33 | 22.3 | 21.8 | 0.98 | 0.54 | 0.04 | Example |
| 34 | 24.5 | 23.9 | 0.98 | 0.60 | 0.02 | Example |
| 35 | 23.6 | 21.8 | 0.92 | 0.53 | 0.10 | Example |
| 36 | 21.2 | 19.9 | 0.94 | 0.54 | 0.06 | Example |
| 37 | 10.8 | 4.4 | 0.41 | 0.65 | 0.65 | Comparative |
| | | | | | | Example |
| 38 | 14.2 | 10.9 | 0.77 | 0.81 | 0.50 | Example |
| 39 | 25.3 | 25.0 | 0.99 | 0.77 | 0.01 | Example |
| 40 | 14.1 | 10.2 | 0.72 | 0.62 | 0.50 | Example |
| 41 | 8.5 | 7.1 | 0.84 | 0.58 | 0.20 | Example |
| 42 | 13.3 | 12.9 | 0.97 | 0.57 | 0.05 | Example |
| 43 | 14.6 | 14.6 | 1.00 | 0.56 | 0.04 | Example |
| 44 | 15.4 | 10.2 | 0.66 | 0.70 | 0.50 | Example |
| 45 | 9.9 | 9.8 | 0.99 | 2.01 | 0.01 | Example |

Underlines indicate outside the range according to the present disclosure.
¹⁾CR: cold-rolled steel sheet, GI: hot-dip galvanized steel sheet (without alloying treatment of galvanizing), GA: galvannealed steel sheet

In each Example, the sound wave irradiation was performed on the steel sheet, so that a steel sheet excellent in hydrogen embrittlement resistance was able to be produced.

### REFERENCE SIGNS LIST

60 sound wave irradiator
62 sound wave oscillator
64 vibration transducer
66 booster
68 horn
69 sound pressure controller
70 sound level meter
71 heater
72 box-shaped portion
80 housing
90 coil holder
300a, 300b dehydrogenation apparatus
S steel strip
C steel sheet coil

1. A dehydrogenation apparatus comprising:
a housing configured to house a steel sheet coil obtained by coiling a steel strip; and
a sound wave irradiator configured to irradiate the steel sheet coil housed in the housing with sound waves to obtain a product coil.

2. The dehydrogenation apparatus according to claim 1, wherein an intensity of the sound waves generated from the sound wave irradiator and a position of the sound wave irradiator are set so that a maximum sound pressure level at a surface of the steel sheet coil will be 30 dB or more.

3. The dehydrogenation apparatus according to claim 1, further comprising a heater configured to heat the steel sheet coil while the steel sheet coil is irradiated with the sound waves.

4. A dehydrogenation apparatus comprising:
an uncoiler configured to uncoil a steel sheet coil to feed a steel strip;
a sheet passing device configured to pass the steel strip therethrough;
a coiler configured to coil the steel strip; and
a sound wave irradiator configured to irradiate the steel strip being passed through the sheet passing device with sound waves to obtain a product coil.

5. The dehydrogenation apparatus according to claim 4, wherein an intensity of the sound waves generated from the sound wave irradiator and a position of the sound wave irradiator are set so that a maximum sound pressure level at a surface of the steel strip will be 30 dB or more.

6. The dehydrogenation apparatus according to claim 4, further comprising a heater configured to heat the steel strip while the steel strip is irradiated with the sound waves.

7. The dehydrogenation apparatus according to claim 1, further comprising a sound absorber configured to prevent the sound waves from leaking out of the dehydrogenation apparatus.

8. A steel sheet production system comprising:
a hot rolling mill configured to subject a steel slab to hot rolling to obtain a hot-rolled steel sheet;
a hot-rolled steel sheet coiler configured to coil the hot-rolled steel sheet to obtain a hot-rolled coil; and
the dehydrogenation apparatus according to claim 1 configured to use the hot-rolled coil as the steel sheet coil.

9. A steel sheet production system comprising:
a cold rolling mill configured to subject a hot-rolled steel sheet to cold rolling to obtain a cold-rolled steel sheet;
a cold-rolled steel sheet coiler configured to coil the cold-rolled steel sheet to obtain a cold-rolled coil; and
the dehydrogenation apparatus according to claim 1 configured to use the cold-rolled coil as the steel sheet coil.

10. A steel sheet production system comprising:
a batch annealing furnace configured to subject a cold-rolled coil or a hot-rolled coil to batch annealing to obtain an annealed coil; and
the dehydrogenation apparatus according to claim 1 configured to use the annealed coil as the steel sheet coil.

11. A steel sheet production system comprising:
a pre-annealing uncoiler configured to uncoil a cold-rolled coil or a hot-rolled coil to feed a cold-rolled steel sheet or a hot-rolled steel sheet, respectively;
a continuous annealing furnace configured to subject the cold-rolled steel sheet or the hot-rolled steel sheet to continuous annealing to obtain an annealed steel sheet;
an annealed steel sheet coiler configured to coil the annealed steel sheet to obtain an annealed coil; and
the dehydrogenation apparatus according to claim 1 configured to use the annealed coil as the steel sheet coil.

12. A steel sheet production system comprising:
a coating or plating apparatus configured to form a coating or plating on a surface of a hot-rolled steel sheet or a cold-rolled steel sheet to obtain a coated or plated steel sheet;
a coated or plated steel sheet coiler configured to coil the coated or plated steel sheet to obtain a coated or plated steel sheet coil; and
the dehydrogenation apparatus according to claim 1 configured to use the coated or plated steel sheet coil as the steel sheet coil.

13. The steel sheet production system according to claim 12, wherein the coating or plating apparatus is a hot-dip galvanizing apparatus.

14. The steel sheet production system according to claim 12, wherein the coating or plating apparatus includes: a hot-dip galvanizing apparatus; and an alloying furnace following the hot-dip galvanizing apparatus.

15. The steel sheet production system according to claim 12, wherein the coating or plating apparatus is an electroplating apparatus.

16. A steel sheet production method comprising a sound wave irradiation step of irradiating a steel sheet coil obtained by coiling a steel strip with sound waves so that a sound pressure at a surface of the steel sheet coil will be 30 dB or more, to obtain a product coil.

17. The steel sheet production method according to claim 16, wherein the sound wave irradiation step is performed while holding the steel sheet coil at 300° C. or less.

18. A steel sheet production method comprising:
a step of uncoiling a steel sheet coil to feed a steel strip;
a sheet passing step of passing the steel strip; and
a step of coiling the steel strip to obtain a product coil,
wherein the sheet passing step includes a sound wave irradiation step of irradiating the steel strip with sound waves so that a sound pressure level at a surface of the steel strip will be 30 dB or more.

19. The steel sheet production method according to claim 18, wherein the sound wave irradiation step is performed while holding the steel strip at 300° C. or less.

20. The steel sheet production method according to claim 16, comprising:
a step of subjecting a steel slab to hot rolling to obtain a hot-rolled steel sheet; and
a step of coiling the hot-rolled steel sheet to obtain a hot-rolled coil,
wherein the hot-rolled coil is the steel sheet coil.

21. The steel sheet production method according to claim 16, comprising:
a step of subjecting a hot-rolled steel sheet to cold rolling to obtain a cold-rolled steel sheet; and
a step of coiling the cold-rolled steel sheet to obtain a cold-rolled coil,
wherein the cold-rolled coil is the steel sheet coil.

22. The steel sheet production method according to claim 16, comprising a step of subjecting a cold-rolled coil or a hot-rolled coil to batch annealing to obtain an annealed coil,
wherein the annealed coil is the steel sheet coil.

23. The steel sheet production method according to claim 16, comprising:
a step of uncoiling a cold-rolled coil or a hot-rolled coil to feed a cold-rolled steel sheet or a hot-rolled steel sheet, respectively;
a step of subjecting the cold-rolled steel sheet or the hot-rolled steel sheet to continuous annealing to obtain an annealed steel sheet; and
a step of coiling the annealed steel sheet to obtain an annealed coil,
wherein the annealed coil is the steel sheet coil.

24. The steel sheet production method according to claim 16, comprising:
a coating or plating step of forming a coating or plating on a surface of a hot-rolled steel sheet or a cold-rolled steel sheet to obtain a coated or plated steel sheet; and
a step of coiling the coated or plated steel sheet to obtain a coated or plated steel sheet coil,
wherein the coated or plated steel sheet coil is the steel sheet coil.

25. The steel sheet production method according to claim 24, wherein the coating or plating step includes a hot-dip galvanizing step.

26. The steel sheet production method according to claim 24, wherein the coating or plating step includes: a hot-dip galvanizing step; and an alloying step following the hot-dip galvanizing step.

27. The steel sheet production method according to claim 24, wherein the coating or plating step includes an electroplating step.

28. The steel sheet production method according to claim 16, wherein the product coil is composed of a high strength steel sheet having a tensile strength of 590 MPa or more.

29. The steel sheet production method according to claim 16, wherein the product coil includes a base steel sheet having a chemical composition containing, in mass %,
C: 0.030% or more and 0.800% or less,
Si: 0.01% or more and 3.00% or less,
Mn: 0.01% or more and 10.00% or less,
P: 0.001% or more and 0.100% or less,
S: 0.0001% or more and 0.0200% or less,
N: 0.0005% or more and 0.0100% or less, and
Al: 2.000% or less,
with the balance being Fe and inevitable impurities.

30. The steel sheet production method according to claim 29, wherein the chemical composition further contains, in mass %, at least one element selected from the group consisting of
Ti: 0.200% or less,
Nb: 0.200% or less,
V: 0.500% or less,
W: 0.500% or less,
B: 0.0050% or less,
Ni: 1.000% or less,
Cr: 1.000% or less,
Mo: 1.000% or less,
Cu: 1.000% or less,
Sn: 0.200% or less,
Sb: 0.200% or less,
Ta: 0.100% or less,
Ca: 0.0050% or less,
Mg: 0.0050% or less,
Zr: 0.0050% or less, and
REM: 0.0050% or less.

31. (canceled)

32. (canceled)

33. The steel sheet production method according to claim 16, wherein the product coil has a diffusible hydrogen content of 0.50 mass ppm or less.

34. A steel sheet production system comprising:
a coating or plating apparatus configured to form a coating or plating on a surface of a hot-rolled steel sheet or a cold-rolled steel sheet to obtain a coated or plated steel sheet;
a coated or plated steel sheet coiler configured to coil the coated or plated steel sheet to obtain a coated or plated steel sheet coil; and
the dehydrogenation apparatus according to claim 4 configured to use the coated or plated steel sheet coil as the steel sheet coil.

35. The steel sheet production method according to claim 18, comprising:
a coating or plating step of forming a coating or plating on a surface of a hot-rolled steel sheet or a cold-rolled steel sheet to obtain a coated or plated steel sheet; and
a step of coiling the coated or plated steel sheet to obtain a coated or plated steel sheet coil,
wherein the coated or plated steel sheet coil is the steel sheet coil.

36. The steel sheet production method according to claim 18, wherein the product coil includes a base steel sheet having a chemical composition containing, in mass %,
C: 0.030% or more and 0.800% or less,
Si: 0.01% or more and 3.00% or less,
Mn: 0.01% or more and 10.00% or less,
P: 0.001% or more and 0.100% or less,
S: 0.0001% or more and 0.0200% or less,
N: 0.0005% or more and 0.0100% or less, and
Al: 2.000% or less,
with the balance being Fe and inevitable impurities.

37. The steel sheet production method according to claim 36, wherein the chemical composition further contains, in mass %, at least one element selected from the group consisting of
Ti: 0.200% or less,
Nb: 0.200% or less,
V: 0.500% or less,
W: 0.500% or less,
B: 0.0050% or less,
Ni: 1.000% or less,
Cr: 1.000% or less,
Mo: 1.000% or less,
Cu: 1.000% or less,
Sn: 0.200% or less,
Sb: 0.200% or less,
Ta: 0.100% or less,
Ca: 0.0050% or less,
Mg: 0.0050% or less,
Zr: 0.0050% or less, and
REM: 0.0050% or less.

38. The steel sheet production method according to claim 18, wherein the product coil has a diffusible hydrogen content of 0.50 mass ppm or less.
